(19) United States
(12) Patent Application Publication
(10) Pub. No.: US 2018/0093893 A1
(43) Pub. Date: Apr. 5, 2018

(54) METAL-FREE BIFUNCTIONAL ELECTROCATALYST FOR OXYGEN REDUCTION AND OXYGEN EVOLUTION REACTIONS

(71) Applicant: CASE WESTERN RESERVE UNIVERSITY, Cleveland, OH (US)

(72) Inventor: Liming Dai, Solon, OH (US)

(21) Appl. No.: 15/563,774

(22) PCT Filed: Apr. 4, 2016
(86) PCT No.: PCT/US16/25847

§ 371 Date: Oct. 2, 2017

Related U.S. Application Data
(60) Provisional application No. 62/142,163, filed on Apr. 2, 2015.

(51) Int. Cl. C01B 32/194; C01B 32/15; C01B 32/05; H01M 4/90; H01M 12/08

(52) U.S. Cl. CPC C01B 32/194; C01B 32/15; C01B 32/05; C01P 2006/16; H01M 12/08; C01B 2204/20; H01M 4/90

(57) ABSTRACT

A co-doped carbon material, methods of making such materials, and electrochemical cells and devices comprising such materials are provided. The co-doped carbon material comprises a mesoporous carbon material doped with nitrogen and phoshporous (NPMC). The present NPMC exhibit catalytic activity for both oxygen reduction reaction and oxygen evolution reaction and may be useful as an electrode in an electrochemical cell and particularly as part of a battery. The present NPMC materials may be used as electrodes in primary zinc-air batteries and in rechargeable zinc-air batteries and many other energy systems.

### CROSS-REFERENCE TO RELATED APPLICATION

This application claims priority to U.S. Provisional Patent Application No. 62/142,163, entitled “A Metal-Free Bifunctional Electrocatalyst For Oxygen Reduction And Oxygen Evolution Reactions” filed on Apr. 2, 2015, which is hereby incorporated by reference in its entirety.

### STATEMENT OF GOVERNMENT SUPPORT

This invention was made with government support under Air Force Office of Scientific Research (AFOSR) (FA-9550-12-1-0069, FA9550-12-1-0037), and the National Science Foundation (NSF-AIR-IIP-1343270, NSF-CMMI-1363123). The government has certain rights in the invention.

### FIELD

The present technology relates to low cost, efficient, and durable bifunctional catalysts for oxygen reduction reaction (ORR) and oxygen evolution reaction (OER).

BACKGROUND

Oxygen reduction reaction (ORR) and oxygen evolution reaction (OER) are traditionally carried out with noble metals (such as Pt) and metal oxides (such as RuO₂ and MnO₂) catalysts, respectively. However, these metal-based catalysts often suffer from multiple disadvantages, including high cost, low selectivity, poor stability, and detrimental environmental effects.

Rechargeable metal-air batteries have been targeted as a promising technology to meet the energy requirements for future electric vehicles and other energy-demanding devices, due to their high energy densities. (Dunn, B., Kamath, H. & Tarascon, J.-M. Electrical energy storage for the grid: A battery of choices. Science 334, 928-935 (2011); Peng, Z., Freunberger, S. A., Chen, Y. & Bruce, P. G., A reversible and higher-rate Li—O₂ battery. Science 337, 563-566 (2012); Park, M., Sun, H., Lee, H., Lee, J. & Cho, J. Lithium-air batteries: Survey on the current status and perspectives towards automotive applications from a battery industry standpoint. Adv. Energy Mater. 2, 780-800 (2012); Goodenough, J. B. Evolution of strategies for modern rechargeable batteries. Accounts Chem. Res. 46, 1053-1061 (2013).) Oxygen reduction reaction (ORR) and oxygen evolution reaction (OER) are at the heart of metal-air batteries: oxygen molecules are reduced by electrons from the current collector and combine with the metal dissolved into the electrolyte during discharging; the reverse process occurs during charging. Among the metals targeted for this type of batteries, lithium and zinc are both currently under extensive scrutiny, but Zn-air batteries have the fundamental advantage of being less costly and safer. (Kraytsberg, A. & Ein-Eli, Y. The impact of nano-scaled materials on advanced metal-air battery systems. Nano Energy 2, 468-480 (2013); Li, Y. et al. Advanced zinc-air batteries based on high-performance hybrid electrocatalysts. Nature Commun. 4, 1805 (2013);Lee, J.-S. et al. Metal-air batteries with high energy density: Li-air versus Zn-air. Adv. Energy Mater. 1, 34-50 (2011).) One of the major challenges for Zn-air battery technology is to increase the O₂ reduction and evolution efficiencies, which requires the development of stable and effective bifunctional electrocatalysts possibly working in aqueous electrolytes with air as the oxygen source. (Li, Y. et al. Advanced zinc-air batteries based on high-performance hybrid electrocatalysts. Nature Commun. 4, 1805 (2013); Chen, Z. et al. Highly active and durable core-corona structured bifunctional catalyst for rechargeable metal-air battery application. Nano Letters 12, 1946-1952 (2012).) Although precious metals, such as Pt, Ru and Ir have been used as such electrocatalysts (Morales, L. & Fernandez, A. M. Unsupported PtₓRu_{y}Ir_{z} and PtₓTr_{y} as bi-functional catalyst for oxygen reduction and oxygen evolution reactions in acid media, for unitized regenerative fuel cell. Int. J. Electrochem. Sci. 8, 12692-12706 (2013)), their high cost and poor stability hamper commercialization of the Zn-air battery technology.

Recent studies have shown that carbon nanomaterials (carbon nanotubes, graphene) doped with nitrogen could be an efficient, low-cost, metal-free alternative to Pt for ORR. Gong, K., Du, F., Xia, Z., Durstock, M. & Dai, L. Nitrogen-doped carbon nanotube arrays with high electrocatalytic activity for oxygen reduction. Science 323, 760-764 (2009); Liu, R., Wu, D., Feng, X. & Mullen, K. Nitrogen-doped ordered mesoporous graphitic arrays with high electrocatalytic activity for oxygen reduction. Angew. Chem. Int. Ed. 49, 2565-2569 (2010); Wang, S. et al. BCN graphene as efficient metal-free electrocatalyst for the oxygen reduction reaction. Angew. Chem. Int. Ed. 51, 4209-4212 (2012); Zheng, Y., Jiao, Y., Ge, L., Jaroniec, M. & Qiao, S. Z. Two-step boron and nitrogen doping in graphene for enhanced synergistic catalysis. Angew. Chem. Int. Ed. 52, 3110-3116 (2013).) Co-doping N-doped carbon nanomaterials with a second heteroatom, such as B, S, or P, can modulate the electronic properties and surface polarities to further increase ORR activities. (Wang, S. et al. Vertically aligned BCN nanotubes as efficient metal-free electrocatalysts for the oxygen reduction reaction: A synergetic effect by co-doping with boron and nitrogen. Angew. Chem. Int. Ed. 50, 11756-11760 (2011); Liang, J., Jiao, Y., Jaroniec, M. & Qiao, S. Z. Sulfur and nitrogen dual-doped mesoporous graphene electrocatalyst for oxygen reduction with synergistically enhanced performance. Angew. Chem. Int. Ed. 51, 11496-11500 (2012); Xue, Y. et al. Three-dimensional B,N-doped graphene foam as a metal-free catalyst for oxygen reduction reaction. Phys. Chem. Chem. Phys. 15, 12220-12226 (2013); Jiao, Y., Zheng, Y., Jaroniec, M. & Qiao, S. Z. Origin of the electrocatalytic oxygen reduction activity of graphene-based catalysts: a roadmap to achieve the best performance. J Am. Chem. Soc. 136, 4394-4403 (2014).) In contrast, most electrocatalysts for OER reported so far are based on transition metal oxides (Grimaud, A. et al. Double perovskites as a family of highly active catalysts for oxygen evolution in alkaline solution. Nature Commun. 4, 2439 (2013)) supported by carbon materials to facilitate electron transfer. (Chen, S., Duan, J., Jaroniec, M. & Qiao, S. Z. Three-dimensional N-doped graphene hydrogel/NiCo double hydroxide electrocatalysts for highly efficient oxygen evolution. Angew. Chem. Int. Ed. 52, 13567-13570 (2013); Zhao, Y., Nakamura, R., Kamiya, K., Nakanishi, S. & Hashimoto, K. Nitrogen-doped carbon nanomaterials as non-metal electrocatalysts for water oxidation. Nature Commun. 4, 2390 (2013); Tian, J., Liu, Q., Asiri, A. M., Alamry, K. A. & Sun, X. Ultrathin graphitic C₃N₄ nanosheets/graphene composites: efficient organic electrocatalyst for oxygen evolution reaction. ChemSusChem 7, 2125-2130 (2014); Ng, J. W. D., Tang, M. & Jaramillo, T. F. A carbon-free, precious-metal-free, high-performance O₂ electrode for regenerative fuel cells and metal-air batteries. Energy Environ. Sci. 7, 2017-2024 (2014); Chen, S., Duan, J., Jaroniec, M. & Qiao, S.-Z. Nitrogen and oxygen dual-doped carbon hydrogel film as a substrate-free electrode for highly efficient oxygen evolution reaction. Adv. Mater. 26, 2925-2930 (2014); Ma, T. Y., Dai, S., Jaroniec, M. & Qiao, S. Z. Graphitic carbon ntride nanosheet-carbon nanotube three-dimensional porous composites as high-performance oxygen evolution electrocatalysts. Angew.Chem. Int. Ed. 53, 7281-7285 (2014).) Although the development of metal-based bifunctional catalysts has recently attracted considerable attention (Prabu, M., Ramakrishnan, P. & Shanmugam, S. CoMn₂O₄ nanoparticles anchored on nitrogen-doped graphene nanosheets as bifunctional electrocatalyst for rechargeable zinc-air battery. Electrochem. Commun. 41, 59-63 (2014)), the use of carbon nanomaterials as bifunctional catalysts has been rarely discussed (Tian, G.-L. et al. Nitrogen-doped graphene/carbon nanotube hybrids: In situ frmation on bifunctional ctalysts and their superior electrocatalytic activity for oxygen evolution/reduction reaction. Small 10, 2251-2259 (2014)), and no truly metal-free bifuncational ORR and OER catalyst has been reported so far.

### SUMMARY

The present technology provides a co-doped carbon material that is suitable for use as an electrode in an electrochemical cell. In one aspect, the present technology provides a mesoporous carbon foam co-doped with nitrogen and phosphorous. In one embodiment, the mesoporous carbon foam co-doped with nitrogen and phosphorous is substantially free of a metal. In one embodiment, the co-doped carbon material possesses a relatively large surface area. In one embodiment, the surface area is about 1663 m² g⁻¹.

In one embodiment, the mesoporous carbon foam co-doped with nitrogen and phosphorous is produced by a one-step process involving the pyrolysis of a polyaniline aerogel synthesized in the presence of phytic acid.

In one aspect, the present technology provides an electrochemical cell comprising the co-doped carbon material. The mesoporous carbon foam co-doped with nitrogen and phosphorous exhibits good electrocatalytic properties for both ORR and OER. In one embodiment, the electrochemical cell is a battery. In one embodiment, the electrochemical cell is a zinc-air battery.

In one embodiment, the battery is rechargeable. The rechargeable battery may comprise two or three electrodes, at least one of which comprises a mesoporous carbon foam co-doped with nitrogen and phosphorous. In one embodiment, each electrode in the rechargeable battery comprises a mesoporous carbon foam co-doped with nitrogen and phosphorous.

In one aspect, the present invention provides a co-doped carbon material comprising a mesoporous nanocarbon foam co-doped with nitrogen and phosphorous. The co-doped carbon material is a bifunctional catylst for both oxygen reduction reaction (ORR) and oxygen evolution reaction (OER).

In one embodiment, the mesoporous nanocarbon foam co-doped with nitrogen and phosphorous is substantially free of metal. In one embodiment, the mesporous nanocarbon foam is devoid of metal.

In one embodiment, the mesoporous nanocarbon foam co-doped with nitrogen and phosphorous comprises about 0.1 wt. % to about 30 wt. %; 0.5 wt. % to about 25 wt. % nitrogen; about 1 wt. % to about 20 wt. % nitrogen; about 1 wt. % to about 10 wt. % nitrogen, about 3 wt. % to about 20 wt. % nitrogen, about 3 wt. % to about 15 wt. %, about 3 wt. % to about 10 wt. % nitrogen, or about 5 wt. % to about 10 wt. % nitrogen. In one embodiment, the mesoporous nanocarbon foam co-doped with nitrogen and phosphorous comprises about 1 wt. %, about 2 wt. %, about 3 wt. %, about 4 wt. %, about 5 wt. %, about 6 wt. %, about 7 wt. %, about 8 wt. %, about 9 wt. %, or about 10 wt. % nitrogen.

In one embodiment, the mesoporous nanocarbon foam co-doped with nitrogen and phosphorous comprises about 0.1 wt. % to about 20 wt. % phosphorous; about 0.1 wt. % to about 15 wt. %; about 0.1 wt. % to about 10 wt. % phosphorous; about 0.1 wt. % to about 5 wt. % phosphorous; about 0.5 wt. % to about 15 wt. % phosphorous; about 0.5 wt. % to about 10 wt. % phosphorous; about 0.5 wt. % to about 5 wt. % phosphorous; about 1 wt. % to about 10 wt. % phosporous; about 1 wt. % to about 5 wt. % phosphorous; about 0.1 wt. % to about 5 wt. % phosphorous; about 3 wt. % to about 10 wt. % phosphorous, or about 3 wt. % to about 5 wt. % phosphorous. In one embodiment, the mesoporous nanocarbon foam co-doped with nitrogen and phosphorous comprises about 0.1wt. %, about 0.5 wt. %, about 1 wt. %, about 2 wt. %, about 3 wt. %, about 4 wt. %, about 5 wt. %, about 6 wt. %, or about 7 wt. % phosphorous.

In one embodiment, the the mesoporous nanocarbon foam co-doped with nitrogen and phosphorous comprisesa total pore pore volume of about 0.3 to about 2.0 cm³g⁻¹; about 0.3 to about 1.5 cm³g⁻¹; about 0.4 to about 2.0 cm³g⁻¹; about 0.4 to about 1.5 cm³g⁻¹; about 0.5 to about 2.0 cm³g⁻¹; or about 0.5 to about 1.5 cm³g⁻¹.

In one aspect, the present invention proivdes an electrochemcial cell comprising at least one electrode, wherein the at least one electrode comprises a co-doped nanocarbon material comprising a mesoporous carbon foam co-doped with nitrogen and phosporous.The electrochemical cell may be a battery. In one embodiment, it is a zinc-air battery. In another embodiment, it is a rechargeable zinc-air battery.

The electrochemical cell may comprise at least two electrodes, one of which comprises the mesoporous nanocarbon foam co-doped with nitrogen and phosphorous. In one embodiment, the electrochemcial cell comprises three electrodes, two of which comprise the mesoporous nanocarbon foam co-doped with nitrogen and phosphorous. In another embodiment each electrode present in the electrochemical cell comprises the mesoporous carbon foam co-doped with nitrogen and phosphorous.

In one aspect, the present technology provides a process for making mesoporous carbon foams comprising pyrolyzing polyaniline aerogels obtained from a template-free polymerization of aniline in the presence of phytic acid.

In one embodiment, the polyaniline aerogel may be formed by (i) polymerizing aniline monomers in the presence of phytic acid to produce a polyaniline hydrogel and (ii) freeze drying the polyaniline hydrogel to form an aerogel.

In one embodiment, the polyaniline aerogel may be formed from a template-free polymerization of aniline in the presence of phytic acid.

The resulting aerogel may be pyrolzed in argon. Pyrolyis may be conducted at a temperature in the range of about 800° C. to about 1200° C.; about 800° C. to about 1100° C.; about 800° C. to about 1000° C.; 900° C. to about 1200° C.; about 900° C. to about 1100° C., or about 900° C. to about 1000° C. In one embodiment, pyrolysis is conducted at temperature of about 1000° C.

In one embodiment, the ratio of aniline to phytic acid is about 3:1 or greater.

These and other aspects and embodiments are further understood with reference to the Figures and Detailed Description.

### BRIEF DESCRIPTION OF THE DRAWINGS

FIGS. 1(a)-(e) show aspects related to the preparation of nitrogen and phosphorus co-doped porous carbon (NPMC) materials and electrocatalysts.

FIG. 1a is a schematic illustration of the preparation process of nitrogen and phosphorus co-doped porous carbon (NPMC) foams.

FIG. 1b is an SEM images of PANi aerogel.

FIG. 1c is an SEM image of NPMC-1000. The inset is the digital photo-image of PANi aerogel before (left) and after (right) pyrolysis at 1000° C.

FIG. 1d is a HRTEM image of the NPMC.

FIG. 1e is a TEM image with the corresponding element mapping images of NPMC-1000. The TEM image shows a piece of interconnected network-like scaffold. The element mapping for carbon, nitrogen, phosphorous shows a uniform distribution of the elements.

FIG. 2 shows the BET characterization and XPS composition analysis of NPMC material.

FIG. 2a shows N₂ adsorption-desorption isotherms for PANi aerogel NPMC-900, NPMC-1000, and NPMC-1100, respectively.

FIG. 2b shows the corresponding pore size distributions for PANi aerogel, NPMC-900, NPMC-1000, and NPMC-1100, respectively.

FIG. 2c shows high-resolution XPS spectra of Nᵢₛ for PANi aerogel NPMC-900, NPMC-1000, and NPMC-1100, respectively.

FIG. 2d shows high-resolution XPS spectra of P₂ₚ for PANi aerogel, NPMC-900, NPMC-1000, and NPMC-1100, respectively. For PANi aerogel, the fitted peaks in (c) correspond to quinonoid imine (QI), benzenoid amine (BA), and nitrogen cationic radical (NC). For NPMC samples, the fitted peaks in (c) correspond to oxidized pyridinic nitrogen (NO), pyridinic-N (N1), pyrrolic-N (N2), and graphitic-N (N3), respectively. For PANi aerogel, the fitted peaks in (d) correspond to phosphorus atoms in phosphate species (as indicated by P1 and P2) with different banding energies. For NPMC samples, the fitted peaks in (d) correspond to P—C and P—O, respectively.

FIG. 3 shows electrocatalytic activity for ORR and OER of the NPMC material.

FIG. 3a shows LSV curves of NPMC-900, NPMC-1000, NPMC-1100, NMC-1000, NPC-1000, and commercial Pt/C catalyst at a RDE (1600 rpm) in O₂ saturated 0.1 M KOH solution. Scan rate: 5 mV s⁻¹.

FIG. 3b shows LSV curves of NPMC-1000 in oxygen-saturated 0.1 M KOH at various rotating speeds.

FIG. 3c shows the K-L plots of the kinetic current (jₖ) vs. the electrode rotating rate (co) for NPMC-1000 and Pt/C at various potentials.

FIG. 3d shows the kinetic current of various samples for O₂ reduction at 0.65 V. e, RRDE measurements (1600 rpm) of ORR at NPMC-1000 electrode with different catalyst loadings. f, LSV curves of NPMC-1000, NPMC-1100, RuO₂ and commercial Pt/C catalyst on a RDE (1600 rpm) in 0.1 M KOH (scan rate: 5 mV s⁻¹), showing the electrocatalytic activities towards both ORR and OER.

FIG. 4 shows the performance of primary Zn-air battery.

FIG. 4a is a schematic illustration for the basic configuration of a primary Zn-air battery, in which a carbon paper pre-coated with NPMC is used as an air cathode and is coupled with a Zn anode, and a glassy fibre membrane soaked with aqueous KOH electrolyte as separator. The enlarged part illustrates the porous air electrode loaded with electrocatalyst, which is permeable to air and oxygen.

FIG. 4b shows polarization and power density curves of the primary Zn-air batteries using Pt/C, NPMC-900, NPMC-1000, NPMC-1100 as ORR catalyst (mass loading: 0.5 mg cm⁻²) and 6 M KOH electrolyte (scan rate: 5 mV/s).

FIG. 4c shows specific capacities of the Zn-air batteries using NPMC-1000 as ORR catalyst were normalized to the mass of the consumed Zn.

FIG. 4d shows discharge curves of the primary Zn-air batteries using Pt/C and NPMC-1000 as ORR catalyst and KOH electrolyte at various current densities (5 and 20 mA cm⁻²).

FIG. 4e shows the long-time durability of the primary Zn-air battery using NPMC-1000 catalyst at a current density of 2 mA cm⁻².

FIG. 4f shows optical images of a LED (˜2.2 V) before and after driven by two Zn-air batteries in series.

FIG. 5 shows performance of rechargeable Zn-air batteries.

FIG. 5a shows discharge/charge cycling curves of two-electrode rechargeable Zn-air batteries at a current density of 2 mA cm⁻² using the NPMC-1000 air electrode.

FIG. 5b is a schematic illustration for the basic configuration of a three-electrode Zn-air battery by coupling Zn electrode with two air electrodes to separate ORR and OER. The enlarged parts illustrate the porous structures of air electrodes, facilitating the gas exchange.

FIG. 5c shows charge and discharge polarization curves of three-electrode Zn-air batteries using the NPMC-1000, NPMC-1100, or commercial Pt/C catalyst as both of the air electrodes, along with the corresponding curve (i.e., Pt/C+RuO₂) for the three-electrode Zn-air battery with Pt/C and RuO₂ nanoparticles as each of the air electrodes, respectively.

FIG. 5d shows discharge/charge cycling curves of a three-electrode Zn-air battery using the NPMC-1000 as the air electrodes (0.5 mg cm⁻² for ORR and 1.5 mg cm⁻² for OER) at a current density of 2 mA cm⁻².

FIG. 6 shows aspects of a mechanism study on bifunctional ORR and OER.

FIGS. 6a and 6b are ORR and OER volcano plots, respectively, of overpotential (η) versus adsorption energy O* and the difference between adsorption energy of O* and OH* for N-doped, P-doped, and N—C—P coupled graphene.

FIG. 6c shows an initial structure, FIG. 6d shows adsorption hydroxyl OH*, FIG. 6e shows adsorption of oxyl O*, and FIG. 6f shows adsorption of peroxyl OOH* intermediates on N and P coupled graphene, where * stands for an active site on the graphene surface and O*, OH* and OOH* are adsorbed intermediates. The overpotentials of the best catalysts predicted theoretically for ORR (Pt) (Norskov, J. K. et al. Origin of the overpotential for oxygen reduction at a fuel-cell cathode. J. Phys. Chem. B 108, 17886-17892 (2004)) and OER (RuO₂) (Man, I. C. et al. Universality in oxygen evolution electrocatalysis on oxide surfaces. ChemCatChem 3, 1159-1165 (2011)) are also plotted in FIGS. 6a and 6b, respectively. The inset in FIG. 6b shows the detail of volcano top in FIG. 6b. Schematic energy profiles for g, the OER pathway and h, ORR pathway on a N,P co-doped graphene in alkaline media.

FIGS. 7a-7f are digital photographs of aniline+water (a), aniline-phytic acid mixed solution with various ratios (b), addition of oxidant (NH₄S₂O₈) into aniline-phytic acid mixed solution for various polymerization times, 2 min (c), 4 min (d), 8 min (e), and 24 h (f).

FIGS. 8a-8d are SEM images of PANi aerogels prepared with various ratios of aniline to phytic acid 1:1 (a), 3:1 (b), 5:1 (c), 7:1 (d).

FIGS. 9a-9d depict FTIR spectra of phytic acid (a), aniline monomer (b), aniline-phytic acid solution with various ratios (c), and PANi aerogel (d).

FIG. 10 is a schematic representation of the formation process of NPMC.

FIG. 11 is a graph depicting TGA curves of PANi aerogel and phytic acid.

FIGS. 12a-12g depict TGA-MS spectroscopic results of PANi aerogel under thermal treatment.

FIGS. 13a and 13b depict HRTEM images of NPMC-1000.

FIGS. 14a-14d depict XRD patterns of PANi aerogel (a), NPMC-900 (b), NPMC-1000 (c), and NPMC-1100 (d).

FIGS. 15a-15d depict Raman spectra of PANi aerogel (a), NPMC-900 (b), NPMC-1000 (c), and NPMC-1100 (d).

FIGS. 16a and 16b depict XPS survey spectra of PANi aerogel (a), NPMC-900 (b), NPMC-1000 (c), NPMC-1100 (D). The absence of any metal signal indicates that NPMCs prepared from the metal-free process are truly metal-free, as also confirmed by ICP analyses.

FIGS. 17a and 17b. FIG. 17a is a bar graph depicting normalized ratios of various nitrogen types, including (from left to right) pyridinic N (N1), pyrolic N (N2), graphitic N (N3), and oxidized pyridinic nitrogen (NO), in NPMC-900, NPMC-1000, and NPMC-1100 from the XPS results in FIG. 2c. FIG. 17(b) is a graphic representation of the percentage content of various nitrogen types with increasing pyrolysis temperature.

FIGS. 18a-18e depict cycle voltammetry curves of NPMC-800 (FIG. 18a), 900 (FIG. 18b), 1000 (FIGS. 18c), and 1100 (FIG. 18d) and commercial Pt/C catalyst (FIG. 18e) in 0.1 M KOH saturated with N₂ (dashed curves) or O₂ (solid curves).

FIG. 19 depicts the electrochemical impedance spectra of NPMC-900, NPMC-1000, and NPMC-1100 in 0.1 M KOH.

FIGS. 20a-20f are graphs depicting LSV curves of NPMC-1100 (a), NMC-1000 (b), NPMC-900 (c), NPC-1000 (d), and Pt/C (e) in oxygen-saturated 0.1 M KOH with various rotating speeds (f).

FIGS. 21a and 21b are graphic representations of the percentage of peroxide in the total oxygen reduction products (a) and the number of electron transfer (b) at the NPMC-1000 electrode based on the RRDE result.

FIGS. 22a and 22b depict the results of RRDE tests (1600 rpm) of various electrodes for ORR in 1 M KOH saturated with oxygen at a scan rate of 5 mV s⁻¹ (a). The calculated electron transfer number and HO₂⁻ generated during ORR (b).

FIGS. 23a and 23b depict the results of, RRDE tests (1600 rpm) of various electrodes for ORR in 6 M KOH saturated with oxygen at a scan rate of 5 mV s⁻¹ (a). The calculated electron transfer number and HO₂⁻ generated from ORR (b).

FIGS. 24a-24c depict the results of stability tests (a) for ORR of NPMC-1000 and Pt/C in oxygen-saturated 0.1 M KOH. The arrow indicates the addition of 3 M methanol (b) and 10% volume CO (c) into the electrochemical cell, respectively.

FIGS. 25a and 25b depict cyclic voltammograms of Pt catalyst (a) and NPMC-1000 (b) in N₂ and O₂ saturated 0.1 M HClO₄, respectively.

FIGS. 26a and 26b depict RRDE measurements (1600 rpm) (a) of ORR at various electrodes (Mass loading of NPMC samples and Pt/C: 0.45 mg cm⁻, 0.15 mg cm², respectively), scan rate: 5 mV s⁻¹, electron transfer number and H₂O₂ yield for ORR in O₂-saturated 0.1 M HClO₄ (b).

FIG. 27 depicts the XRD pattern of RuO₂ nanoparticles.

FIGS. 28a and 28b depict LSV curves (a) and Tafel plots (b) for RuO₂ nanoparticles, Pt/C, NPMC-1000, and NPMC-1100 on a RDE (1600 rpm) in an O₂-saturated 6M KOH solution (scan rate: 5 mV s⁻¹).

FIG. 29 depicts open circle potentials of a Zn-air battery and two batteries in series.

FIG. 30 depicts mechanical recharge cycles for the Zn-air primary battery using NPMC-1000 catalyst (mass loading: 0.5 mg cm⁻²) at a current density of 2 mA cm⁻² and 6 M KOH electrolyte. The Zinc and electrolyte were mechanically replaced at the point where the color of the curve changes (One and Two represent the 1st and 2nd charge cycle, respectively). The red dot above the potential vs. time curve was resulted from the open circle potential by opening the battery for mechanical recharge. The longer discharge duration observed for the second cycle is due to the fact that more Zn (around two-times) was added in the second cycle of mechanical recharge. Nevertheless, the electrode surface area is the same during the first and second cycles, and hence the current density is the same.

FIG. 31 depicts the long-time durability of Zn-air battery using NPMC-1000 catalyst in 1 M KOH electrolyte at a current density of 2 mA cm⁻²

FIG. 32 depicts optical images of LEDs before and after they were powered by two home-made Zn-air batteries in series.

FIG. 33 is a schemic illustration for a two-electrode rechargeable Zn-air battery using NPMC-1000 as bifunctional catalyst.

FIG. 34 depicts discharge/charge cycling curves of a two-electrode Zn-air battery using a mix of Pt/C and RuO₂ as catalyst at a current density of 2 mA cm⁻². In order to measure the performance of mixed Pt/C and RuO₂ catalyst in the Zn-air battery test, a slurry of mixed Pt/C and RuO₂ with a mass ratio of 1:1 was prepared by dispersing Pt/C and RuO₂ into water under sonication. The air electrode was prepared by uniformly coating the as-prepared catalyst slurry onto a carbon paper (SPECTRACARB 2040-A, Fuel Cell store) and dried at 80° C. for 2 h. The total mass loading is 0.5 mg cm⁻².

FIG. 35 depicts the results of discharge-charge cycling tests of a two-electrode rechargeable Zn-air battery using NPMC-1000 as bifunctional catalyst at a current density of 2 mA cm⁻².

FIG. 36 depicts the discharge/charge cycling curves of a three-electrode Zn-air battery using Pt/C and RuO₂ nanoparticles as catalysts for ORR and OER, respectively.

FIGS. 37a and 37b depict a, Armchair and b, Zigzag N and P-codoped graphene structures used in the calculations. The numbers denote N substitutional sites and reaction sites. Symbols a, b, c, d, e, and f denote N, P substitutional sites. Symbols A, B,C, D, E and F, and a#, b#, c#, d#, e#, and f# refer to reaction sites. Isolated N, and P structures and their notation can be seen in detail in Li, M., Zhang, L., Xu, Q., Niu, J., Xia, Z. N-doped Graphene as Catalysts for Oxygen Reduction and Oxygen Evolution Reactions: Theoretical Considerations, J. Catal., 314, 66-72(2014).

These drawings are not to scale unless otherwise noted. The drawings are for the purpose of illustrating aspects and embodiments of the present technology and are not intended to limit the technology to those aspects illustrated therein. Aspects and embodiments of the present technology can be further understood with reference to the following detailed description.

### DETAILED DESCRIPTION

The present technology provides co-doped carbon materials suitable for use ans an electrode catalyst material and methods of making such materials. In one embodiment, the present technology provides mesoporpous nanocarbon co-doped with nitrogen and phosphorous (NPMCs). The NPMCs show bifunctional catalytic activities towards ORR and OER. The peresent technolgoy also provides electrochemical cells comprising such co-doped materials. Zn-air batteries fabricated with NPMCs may show good performance and long-term stability.

The present technology provides a co-doped carbon material that is suitable for use as an electrode catalyst in an electrochemical cell. In one aspect, the present technology provides a mesoporous carbon foam co-doped with nitrogen and phosphorous. In one embodiment, the mesoporous carbon foam co-doped with nitrogen and phosphorous is substantially free of a metal. In one embodiment, the co-doped carbon material possesses a relatively large surface area. In one embodiment, the surface area is about 1663 m² g⁻¹.

In one embodiment, the mesoporous carbon foam co-doped with nitrogen and phosphorous is produced by a one-step process involving the pyrolysis of a polyaniline aerogel synthesized in the presence of phytic acid.

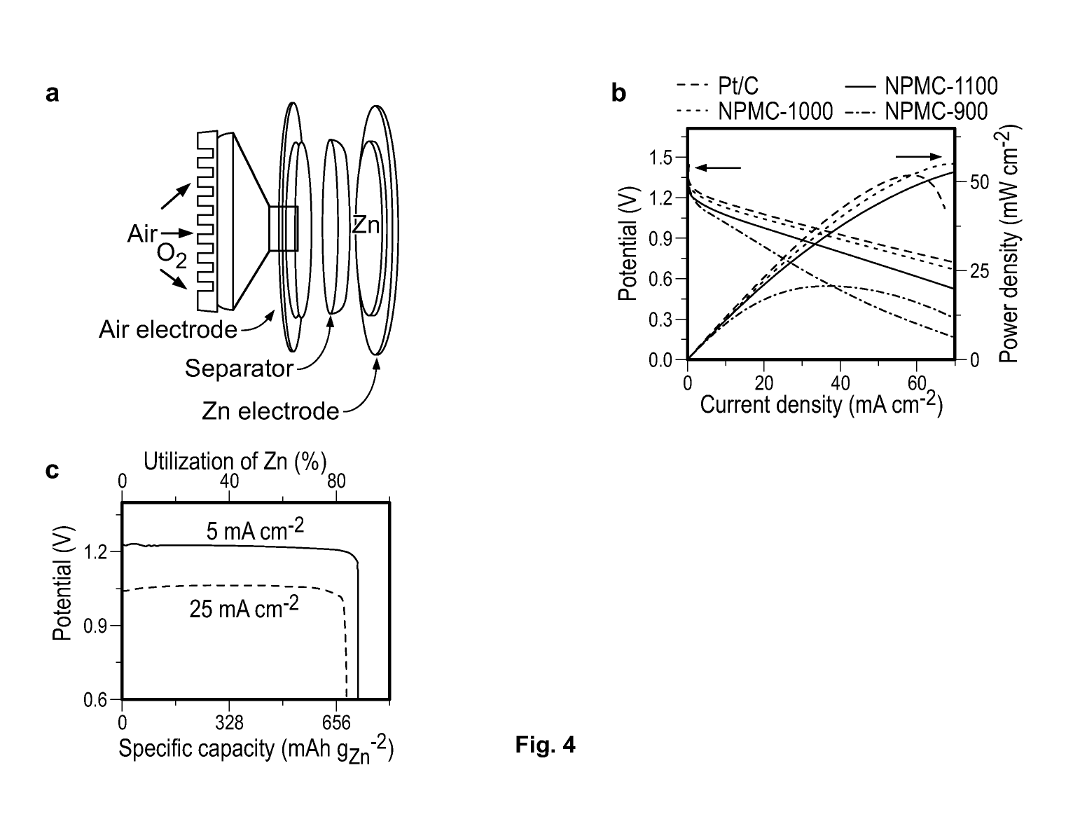

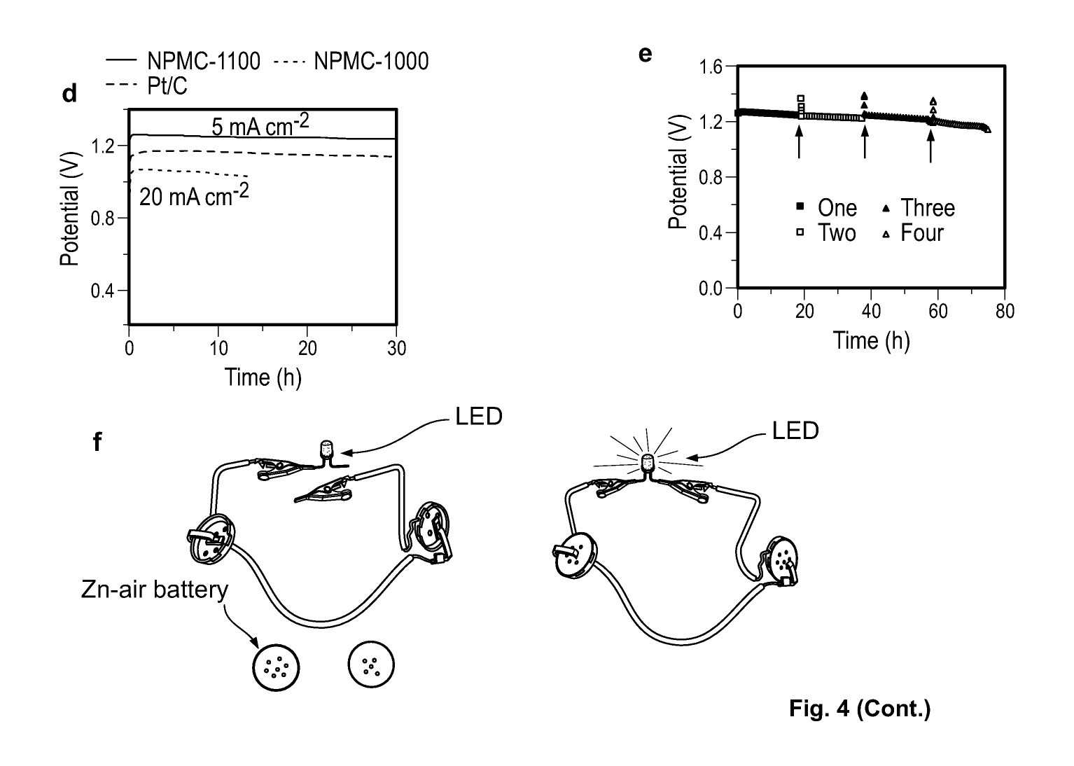

In one aspect, the present technology provides an electrochemical cell comprising at least one electrode comprising a mesoporous carbon foam co-doped with nitrogen and phosphorous. The mesoporous carbon foam co-doped with nitrogen and phosphorous exhibits good electrocatalytic properties for both ORR and OER. In one embodiment, the electrochemical cell is a battery. In one embodiment, the electrochemical cell is a zinc-air battery. The configuration of the electrochemical cell, e.g., a zinc air battery, is not particulary limited and can be selected as desired for a particluar application of intended use. That is, the components of the battery are not so limited, except that the present co-doped carbon materials may be employed in such systems and configurations. FIG. 4a provides a schematic of the basic configuration of a primary zinc-air electrochemical cell with an electrode. According to the invention, the air cathode comprises a carbon paper pre-coated with a mesoporous carbon foam co-doped with nitrogen and phosphorous and is coupled with a zinc anode, and a glassy fibre membrane soaked with aqueous KOH electrolyte as a separator. The enlaged part of the air cathode illustrtes the porous air electrode loaded with electrocatalyst, which is permeable to air and oxygen.

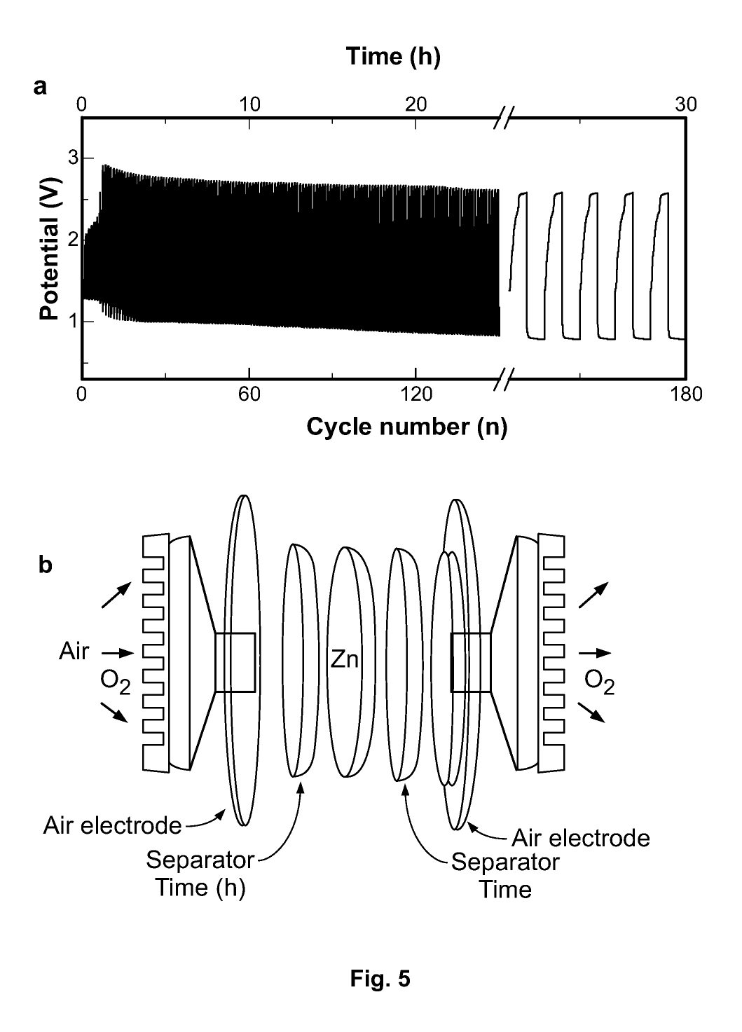

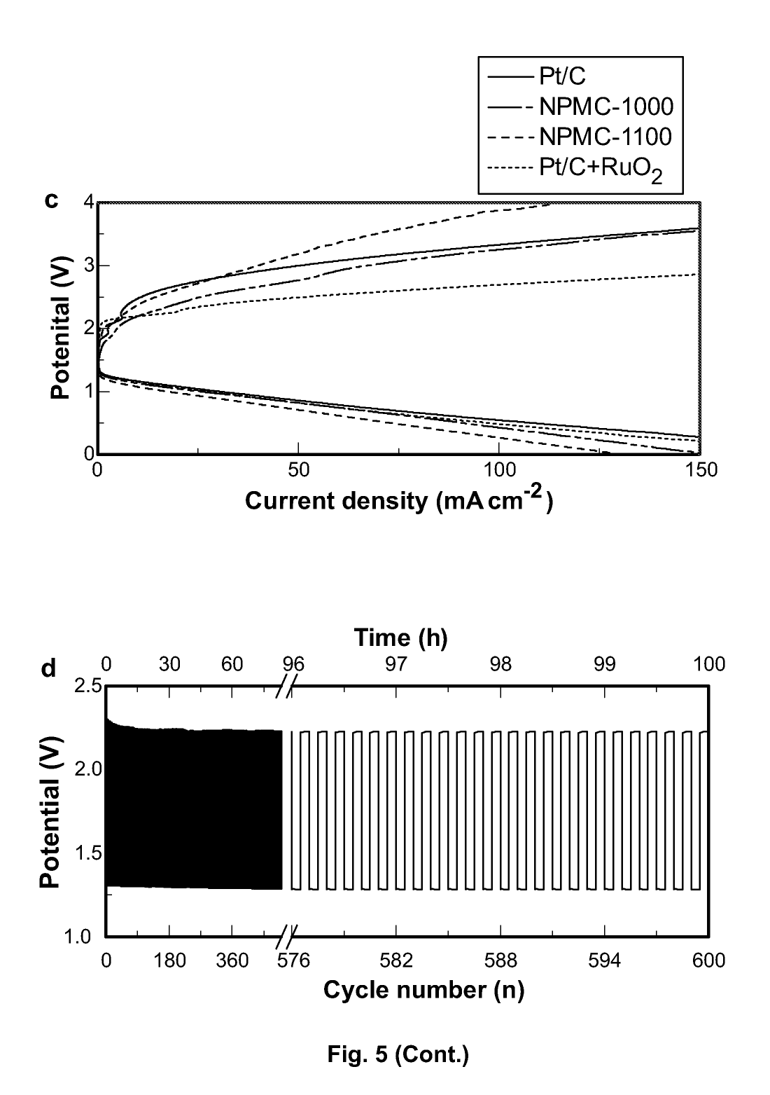

In one embodiment, the battery is rechargeable. The rechargeable battery may comprise two or three electrodes, at least one of which comprises a mesoporous carbon foam co-doped with nitrogen and phosphorous. In one embodiment, each electrode in the rechargeable battery comprises a mesoporous carbon foam co-doped with nitrogen and phosphorous. FIG. 5 illustrates a zinc-air battery configuration comprising a plurality of air electrodes. Each air electrode may comprise or have associated therewith a catalyst material that may comprise a co-doped mesoporous carbon material in accordance with the present invention.

In one aspect, the present invention provides a co-doped carbon material comprising a mesoporous nanocarbon foam co-doped with nitrogen and phosphorous. The co-doped carbon material is a bifunctional catylst for both oxygen reduction reaction (ORR) and oxygen evolution reaction (OER).

In one embodiment, the mesoporous nanocarbon foam co-doped with nitrogen and phosphorous is substantially free of metal. In one embodiment, the mesporous nanocarbon foam is devoid of metal.

In one embodiment, the mesoporous nanocarbon foam co-doped with nitrogen and phosphorous comprises about0.1 wt. % to about 30 wt. %; 0.5 wt. % to about 25 wt. % nitrogen; about 1 wt. % to about 20 wt. % nitrogen; about 1 wt. % to about 10 wt. % nitrogen, about 3 wt. % to about 20 wt. % nitrogen, about 3 wt. % to about 15 wt. %, about 3 wt. % to about 10 wt. % nitrogen, or about 5 wt. % to about l0wt. % nitrogen. In one embodiment, the mesoporous nanocarbon foam co-doped with nitrogen and phosphorous comprises about 1 wt. %, about 2 wt. %, about 3 wt. %, about 4 wt. %, about 5 wt. %, about 6 wt. %, about 7 wt. %, about 8 wt. %, about 9 wt. %, or about 10 wt. % nitrogen.

In one embodiment, the mesoporous nanocarbon foam co-doped with nitrogen and phosphorous comprises about 0.1 wt. % to about 20 wt. % phosphorous; about 0.1 wt. % to about 15 wt. %; about 0.1 wt. % to about 10 wt. % phosphorous; about 0.1 wt. % to about 5 wt. % phosphorous; about 0.5 wt. % to about 15 wt. % phosphorous; about 0.5 wt. % to about 10 wt. % phosphorous; about 0.5 wt. % to about 5 wt. % phosphorous; about 1 wt. % to about 10 wt. % phosporous; about 1 wt. % to about 5 wt. % phosphorous; about 0.1 wt. % to about 5 wt.% phosphorous; about 3 wt. % to about 10 wt. % phosphorous, or about 3 wt. % to about 5 wt. % phosphorous. In one embodiment, the mesoporous nanocarbon foam co-doped with nitrogen and phosphorous comprises about 0.1wt. %, about 0.5 wt. %, about 1 wt. %, about 2 wt. %, about 3 wt. %, about 4 wt. %, about 5 wt. %, about 6 wt. %, or about 7 wt. % phosphorous.

In one embodiment, the the mesoporous nanocarbon foam co-doped with nitrogen and phosphorous comprisesa total pore pore volume of about 0.3 to about 2.0 cm³g⁻¹; about 0.3 to about 1.5 cm³g⁻¹; about 0.4 to about 2.0 cm³g⁻¹; about 0.4 to about 1.5 cm³g⁻¹; about 0.5 to about 2.0 cm³g⁻¹; or about 0.5 to about 1.5 cm³g⁻¹.

In one aspect, the present invention proivdes an electrochemcial cell comprising at least one electrode, wherein the at least one electrode comprises a co-doped nanocarbon material comprising a mesoporous carbon foam co-doped with nitrogen and phosporous.The electrochemical cell may be a battery. In one embodiment, it is a zinc-air battery. In another embodiment, it is a rechargeable zinc-air battery.

The electrochemical cell may comprise at least two electrodes, one of which comprises the mesoporous nanocarbon foam co-doped with nitrogen and phosphorous. In one embodiment, the electrochemcial cell comprises three electrodes, two of which comprise the mesoporous nanocarbon foam co-doped with nitrogen and phosphorous. In another embodiment each electrode present in the electrochemical cell comprises the mesoporous carbon foam co-doped with nitrogen and phosphorous.

### Preparation and Characterization of the Electrocatalyst.

In one aspect, the present technology provides a process for making mesoporous carbon foams comprising pyrolyzing polyaniline aerogels obtained from a template-free polymerization of aniline in the presence of phytic acid. Generally, the polyaniline aerogel may be formed by (i) polymerizing aniline monomers in the presence of phytic acid to produce a polyaniline hydrogel and (ii) freeze drying the polyaniline hydrogel to form an aerogel. In one embodiment, the polyaniline aerogel may be formed from a template-free polymerization of aniline in the presence of phytic acid.

The resulting aerogel may be pyrolzed in argon. Pyrolyis may be conducted at a temperature in the range of about 800° C. to about 1200° C.; about 800° C. to about 1100° C.; about 800° C. to about 1000° C.; 900° C. to about 1200° C.; about 900° C. to about 1100° C., or about 900° C. to about 1000° C. In one embodiment, pyrolysis is conducted at temperature of about 1000° C.

Aspects of making the co-doped mesoporous carbon materials may be further understood with respect to the following discussion.

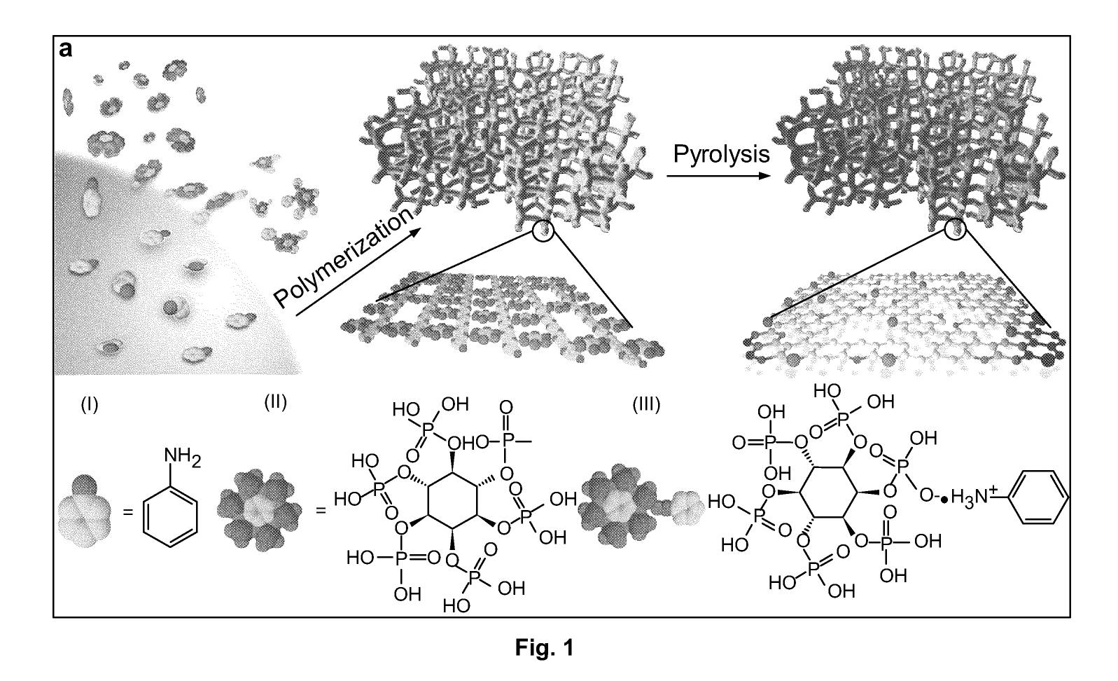

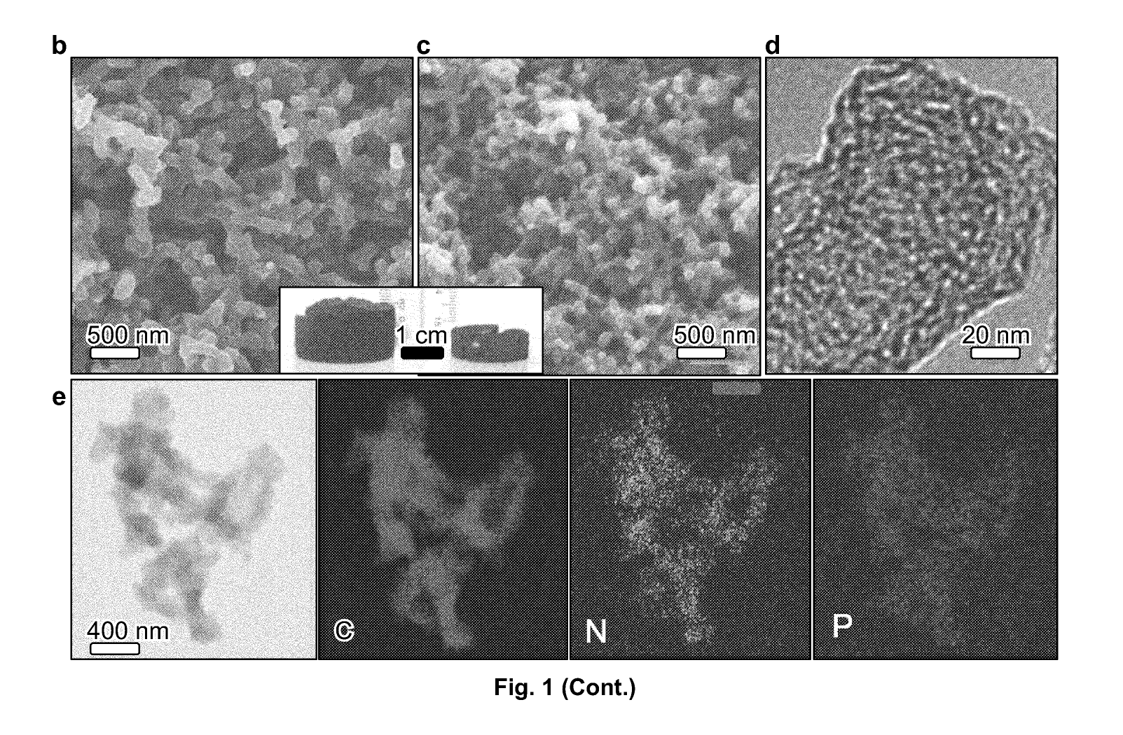

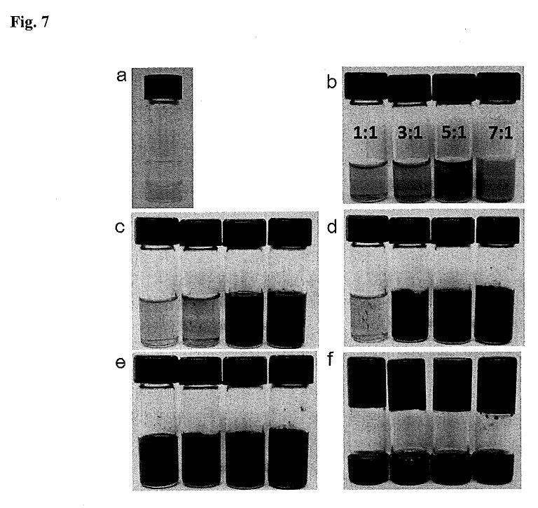

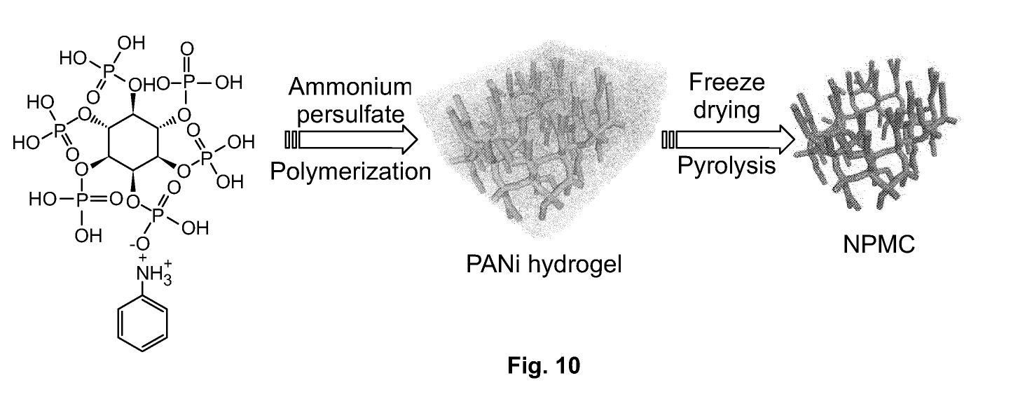

In one aspect, the NPMC material may be made by a template-free method for the scalable fabrication of three-dimensional (3D) N and P co-doped mesoporous nanocarbon (NPMC) foams. The NPMC material may be made by pyrolysis of polyaniline (PANi) aerogels synthesized in the presence of phytic acid. The co-doped mesoporous nanocarbon may be prepared by polymerizing aniline monomers in the presence of phytic acid to produce a PANi hydrogel via a hard template-free gelation process (Pan, L. et al. Hierarchical nanostructured conducting polymer hydrogel with high electrochemical activity. Proc. Natl. Acad. Sci. USA 109, 9287-9292 (2012)) (FIG. 1a). The foams may be prepared through the formation of aniline (I)-phytic acid (II) complex (III), for reasons of clarity, only one of the complexed anilines is shown for an individual phytic acid.), followed by an oxidative polymerization of the complexed aniline into 3D PANi hydrogel cross-linked with phytic acids (As each phytic acid molecule can complex with up to six aniline monomers, phytic acid can be used as the cross-linker and protonic dopant to directly form the 3D PANi hydrogel network. For reasons of clarity, only a piece of the 2D network building block is shown in the enlarged view underneath of the 3D PANi hydrogel.). Then, the PANi hydrogel is freeze dried into aerogel and pyrolyzed in Ar to produce NPMC (For reasons of clarity, only a piece of the 2D N,P co-doped graphitic network building block is shown in the enlarged view underneath of the 3D NPMC). To determine the optimum conditions for the formation of PANi hydrogel, aniline and phytic acid with different ratios were examined (FIGS. 7-10). After freeze drying the resultant PANi hydrogel into aerogel (FIG. 1b), subsequent pyrolysis of the PANi aerogel led to the one-step formation of a NPMC foam shown in FIG. 1c and FIG. 10. As can be seen in the insets of FIGS. 1b and 1c, pyrolysis caused a slight shrinkage of the macroporous structure. The individual mesoporous ligaments (FIG. 1d) are highly interconnected into a hierarchical porous network. The TEM image and associated elemental mapping (FIG. 1e) shows the uniform distribution of C, N, and P, for the sample pyrolized at 1000° C. (NPMC-1000). TGA-MS, XRD, Raman and TEM studies (FIGS. 11-15) revealed that the pyrolysis converted most of the thermally stable domains, such as the benzene rings, into graphitic carbon domains that are co-doped with N and P from PANi and phytic acid, respectively, along with a release of decomposition gases (CO, CO₂; see Table 1, below).

TABLE 1
The possible evolved species during the thermal treatment of
PANi aerogel on the basis of TGA-MS results in FIGS. 12a-12g.

| m/z | Proposed species |
|---|---|
| 12, 44 | CO₂ |
| 12, 28 | CO |
| 44 | N₂O |
| 28 | N₂ |
| 30 | NO |
| 32 | O₂, PH₃ |
| 18 | H₂O |
| 27 | HCN |

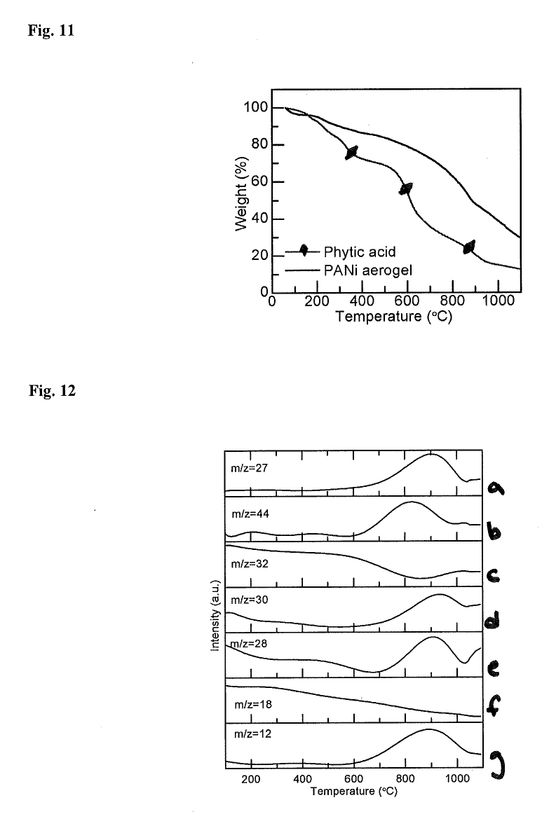

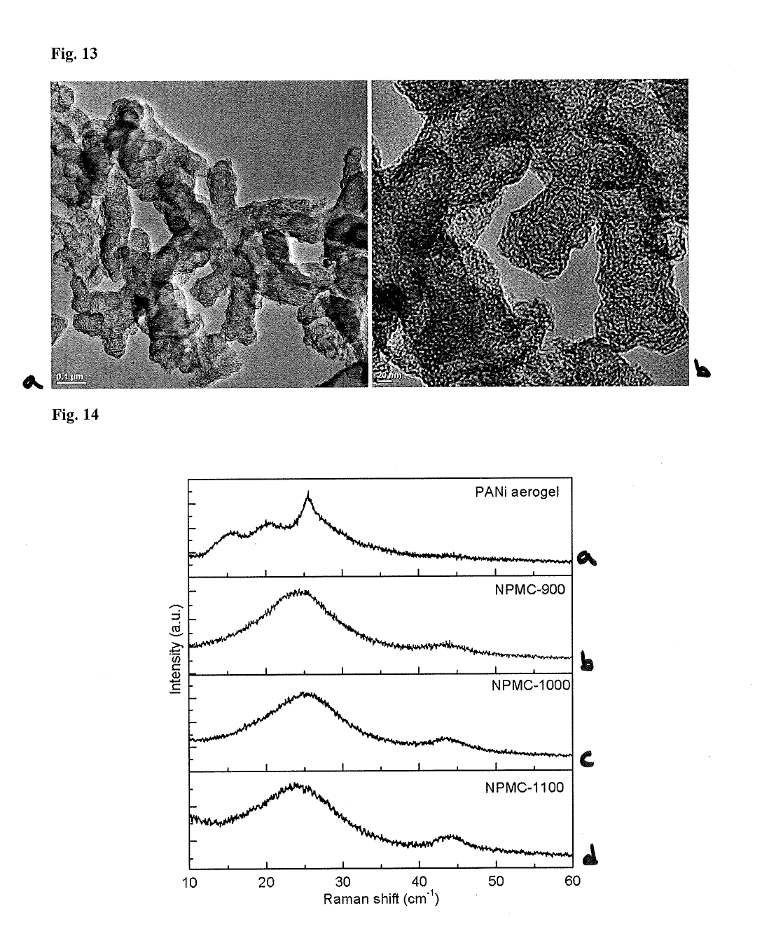

The resulting nanomaterial also possesses a large amount of edge-like graphitic structures (FIGS. 13a and 13b) that play a important role in the catalytic activity. Both the solution polymerization and the template-free pyrolysis process can be readily scaled up for low-cost mass production.

The typical XRD pattern of PANi aerogel exhibits three distinctive diffraction peaks with 20=˜15.5, 20.4 and 25.5° (FIGS. 14a-14d) characteristic of emeraldine salt with a partial crystalline structure, which would be ascribed to the periodicity parallel and perpendicular to the polymer chains of PANI. (Xia, Y., Wiesinger, J. M., MacDiarmid, A. G. & Epstein, A. J. Camphorsulfonic acid fully doped polyaniline emeraldine salt: Conformations in different solvents studied by an ultraviolet/visible/near-infrared spectroscopic method. Chem. Mater. 7, 443-445 (1995).) Upon pyrolysis, the PANi peaks disappeared whilst two broad graphitic (002) and (101) diffraction peaks centred appeared at about 24.5 and 43.7°, respectively (FIGS. 14a-14d).

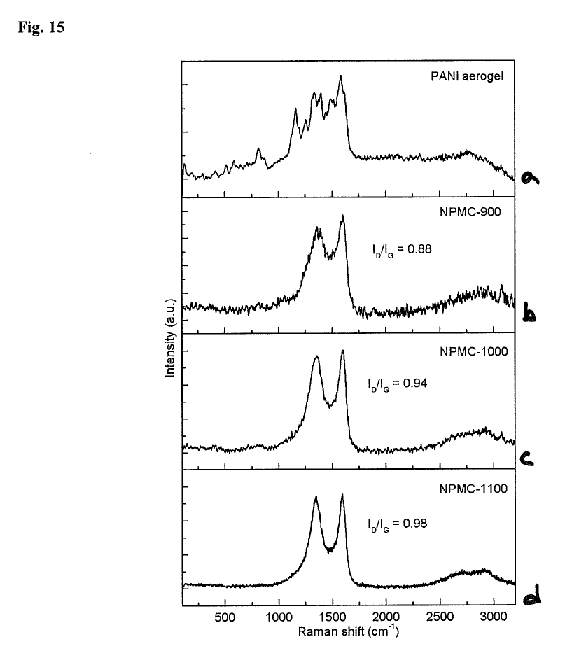

Raman spectrum of the PANi (FIGS. 15a-15d) aerogel exhibits splitted D-, G-bands for the backbone, along with the C—H vibration bands (˜1164 and 1470 cm⁻¹) for quinoid/phenyl groups and semiquinone radical cations, respectively. (Zhang, J. & Zhao, X. S. Conducting polymers directly coated on reduced graphene oxide sheets as high-performance supercapacitor electrodes. J. Phys. Chem. C 116, 5420-5426 (2012).) After pyrolysis, only D- and G-bands at ˜1357 and 1602 cm⁻¹ are observed for NPMC-900 (I_{D}/I_{G}=˜0.88), NPMC-1000 (I_{D}/I_{G}=˜0.94), and NPMC-1100 (I_{D}/I_{G}=˜0.98) (FIGS. 15a-15d). The increased I_{D}/I_{G} ratio with increasing temperature indicates that the higher temperature pyrolysis led to graphitic domains with more defects due to the gas release during pyrolysis.

The oxidative polymerization can be visualized in two steps: a) the solubilization of aniline in an aqueous solution containing phytic acid as a result of the formation of soluable anilinium salt (aniline-phytic acid) via an acid-base reaction. However, aniline is not soluable wholy at high concentration (7:1 in FIG. 7b). b) the addition of oxidant (NH₄S₂O₈) and polymerization to form polyaniline hydrogel gradually (FIGS. 7c-7f).

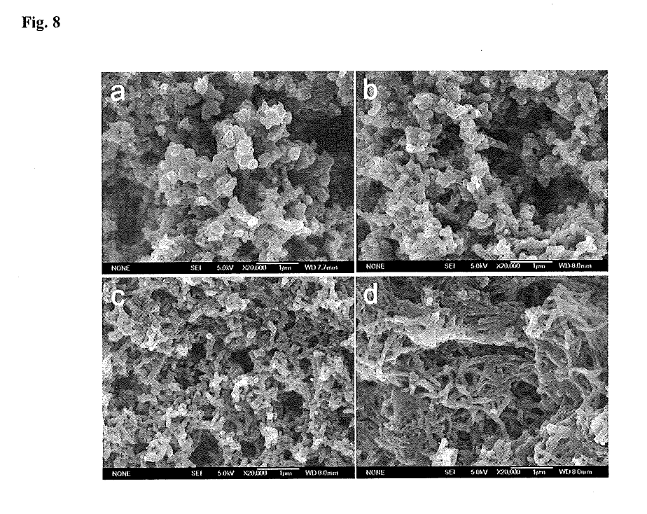

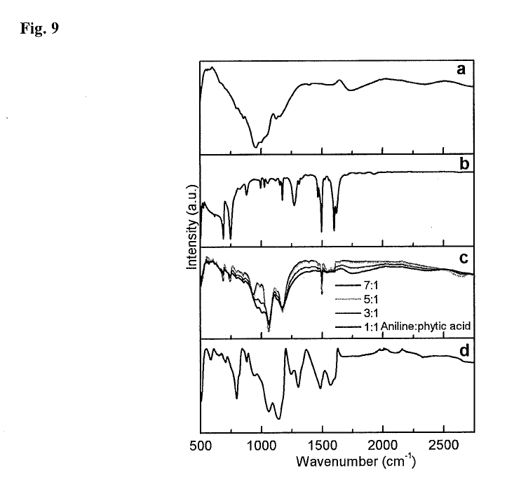

According to the SEM images in FIGS. 8a-8d, the texile structure of final aerogels is depedant on the mole ratio of aniline monomer to phytic acid. The ligament of the porous structure is gradually changed from coralliform to interconnected fibers. The phytic acid could have both surfactant and doping functions. (Lee, K. et al. Metallic transport in polyaniline. Nature 441, 65-68 (2006).) The surfactant function seemes to play an important role in the formation of PANi hydrogels. In comparison with the FTIR spectra of pure phytic acid and aniline monomer (FIGS. 9a-9d), the strong absorption bands of the aniline-phytic acid systems observed in the range of 850˜1200 cm⁻¹ are assigned to phosphate group and protoned —NH— groups, suggesting the formation of aniline-phytic aicd salt. The formation of aniline-phytic aicd salt can not only facilate the solubilization of aniline but also help for the formation of the microstructures as the anilinium salt monomer could act as a surfactant with a polar hydrophilic part and an organic hydrophobic part. (Zhang, Z., Wei, Z. & Wan, M. Nanostructures of polyaniline doped with inorganic acids. Macromolecules 35, 5937-5942 (2002); Zhang, L., Long, Y., Chen, Z. & Wan, M. The Effect of hydrogen bonding on self-assembled polyaniline nanostructures. Adv. Func. Mater. 14, 693-698 (2004).) FIG. 10 schematically shows the process for the formation of PANi hydrogel, followed by freezer drying to yield the PANi aerogel and pyrolysis to produce NPMC. At the low concentration of aniline (anilie:phytic acid, 1:1), spherical micelles could form and become big spheres through accration, and aggregated into coralliform structure during the polymerization (FIG. 8a). With increasing the concentration of aniline, spherical micelles gradually transformed into a cylinder structure, leading to the fromation of hierarchical porous structure composed of interconnected fibers (FIGS. 8b-8d).

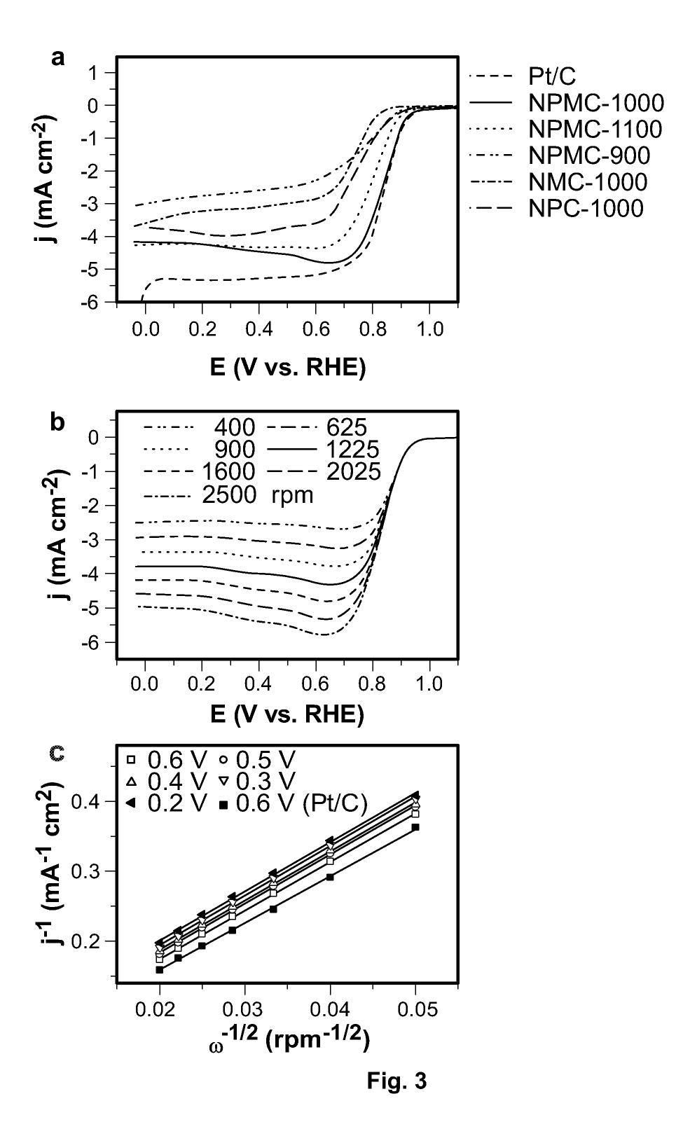

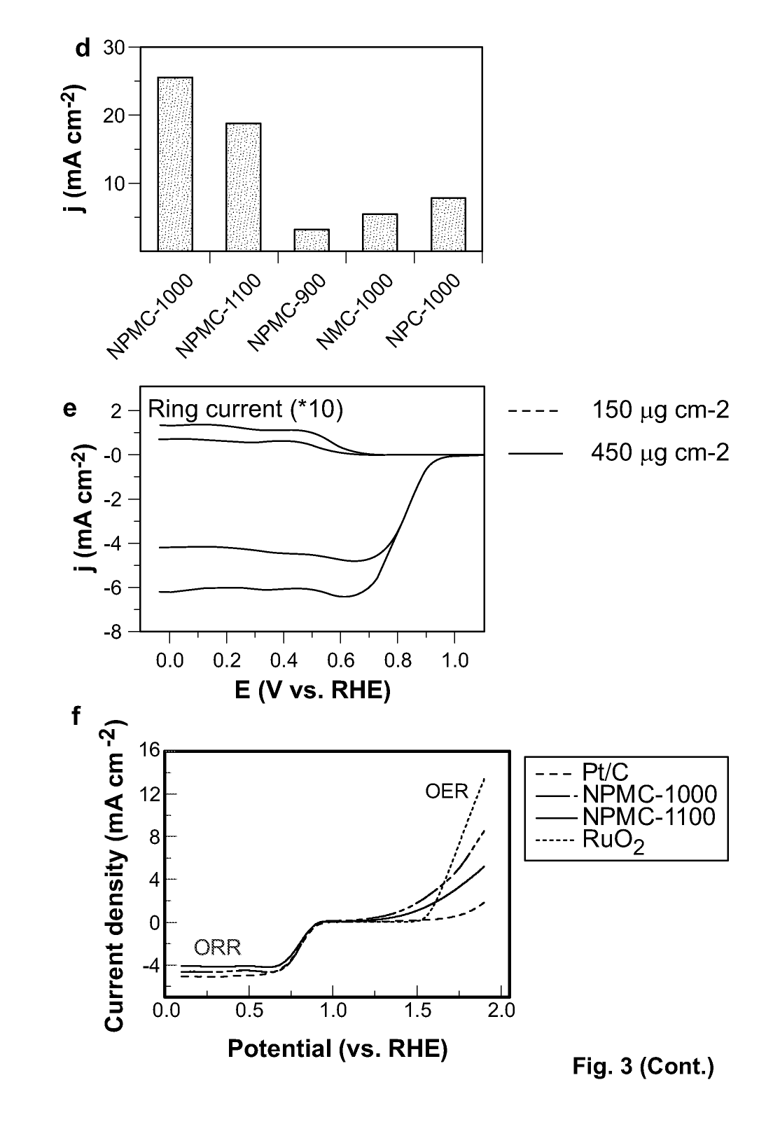

In the FTIR spectra of PANi aerogel (FIG. 3d), the characteristic bands at 1567 and 1485 cm⁻¹ were ascribed to C═C stretching vibration modes in quinoid and benzene rings, respectively, whereas the bands at 1302 and 1244 cm⁻¹ were related to 7E electron delocation caused by protonation and/or C˜N stretching vibration, and the stretching mode of the C˜N⁺ polaron structure formed as a result of the acid doping of the emeraldine base form of PANi. (Zhang, L., Long, Y., Chen, Z. & Wan, M. The Effect of hydrogen bonding on self-assembled polyaniline nanostructures. Adv. Func. Mater. 14, 693-698 (2004).) The band at 1140 cm⁻¹ is the most intense for the NPMC and is attributed to vibration of the —NH¹=structure formed in the acid doping process of PANi. (Gomes, E. C. & Oliveira, M. A. S. Chemical polymerization of aniline in hydrochloric acid (HCl) and formic acid (HCOOH) media. Differences between the two synthesized polyanilines. Am. J. Polymer Sci. 2, 5-13 (2012).) The appearance of the peaks at 1060, 943, 878 cm⁻¹ assigned to vibration of P═O phosphate group suggests the presence of phytic acid. (Cui, X. et al. Influence of phytic acid concentration on performance of phytic acid conversion coatings on the AZ91D magnesium alloy. Mater. Chem. Phys. 111, 503-507 (2008).) These results confirm that the protonation of polyaniline was achieved by phytic acid after polymerization. Especially, phytic acid with multiple phosphate groups can interact with several polyaniline chains to form a cross-linked network sturcture and the excess of phytic acid remains in pores after polymerization. Thus, the presence of phytic acid facilitates stacking and stabilization of PANi during the polymerization process. (Zhang, L., Long, Y., Chen, Z. & Wan, M. The Effect of hydrogen bonding on self-assembled polyaniline nanostructures. Adv. Func. Mater. 14, 693-698 (2004).) The formation of such crosslinked structures is one of the unique features of the present method for the preparation of N, P co-doped porous carbons by pyrolysis with a relaease of decomposition vapors.

The PANi hydrogels were purified by immersing in DI water for 2 days. Notably, the sample obtained at the ratio of aniline:phytic acid (1:1) was broken into small pieces, indicating the unstable structure after removing phytic acid from the pores. In contrast, the hydrogel prepared at higher concentration of aniline (>3:1) was sufficiently stable to maintain the original porous structure, which could be transformed into porous carbons co-doped with nitrogen and phosphrous by pyrolysis. In embodiments, the ratio of aniline:phytic acid may be 3.1:1, 3.5:1, 4:1, 4.5:1, 5:1, or even up to 10:1.

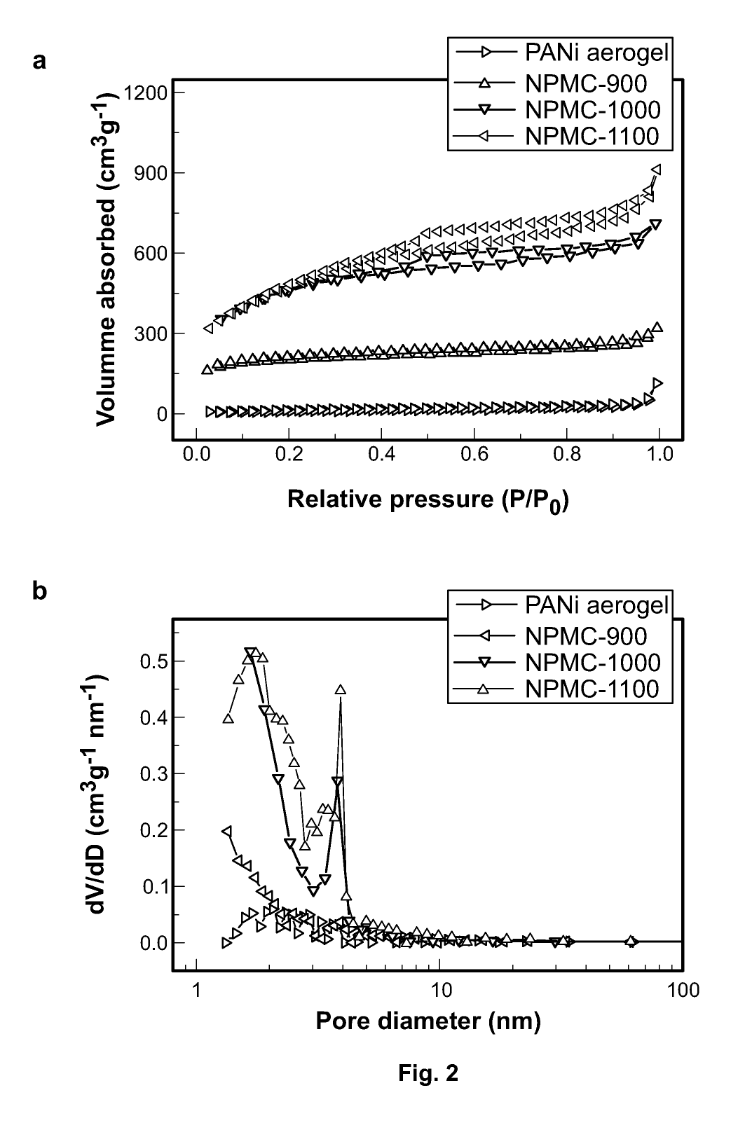

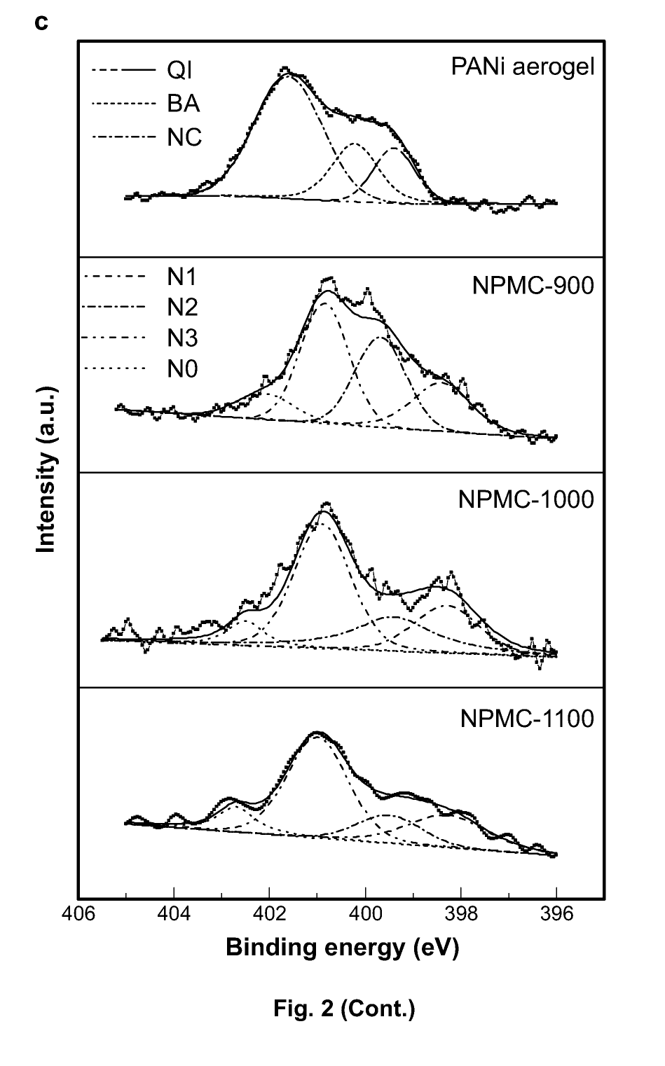

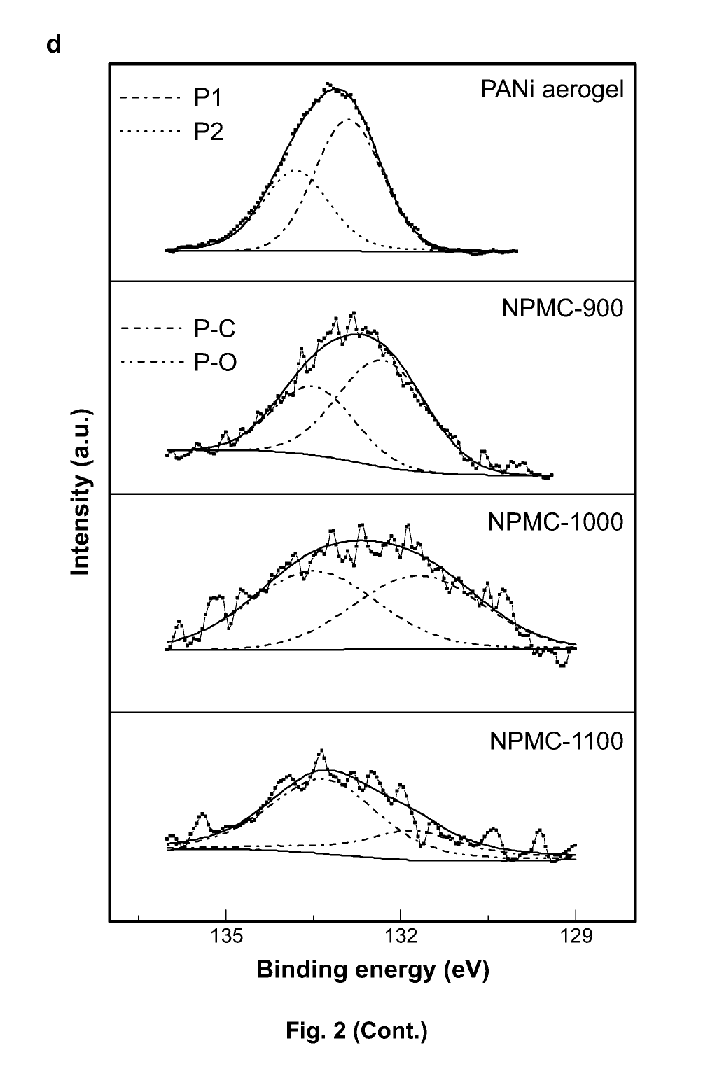

N₂ adsorption-desorption isotherm curves (FIG. 2a) for the NPMC samples exhibit remarkably larger absorbed volumes than that of PANi aerogel, which increased significantly with increasing pyrolysis temperature. The specific surface areas (Table 2, below) are also significantly enlarged by increasing the pyrolysis temperature of the PANi aerogel (53.5 m² g⁻¹).

TABLE 2
Element compositions and specific surface areas (SSA) and
total pore volume (TPV) of PANi aerogel and NPMC samples.

| | SSA | TPV | | | | |
|---|---|---|---|---|---|---|
| Sample | (m² g⁻¹) | (cm³ g⁻¹) | C % | N % | P % | O % |
| PANi aerogel | 53.3 | 0.17 | 48.7 | 6.4 | 6.9 | 38.0 |
| NPMC-900 | 635.6 | 0.50 | 80.4 | 6.1 | 2.7 | 10.8 |
| NPMC-1000 | 1548 | 1.10 | 90.8 | 3.2 | 1.1 | 4.9 |
| NPMC-1100 | 1663 | 1.42 | 94.8 | 1.8 | 0.1 | 3.3 |

In particular, there is a significant difference between the samples heated at 900° C. (NPMC-900, surface area of 635.6 m² g⁻¹) and that heated at 1000° C. (NPMC-1000, surface area of 1548 m² g⁻¹). The observed specific surface areas for NPMC-1000 and NPMC-1100 (1663 m² g⁻¹) are also much larger than those of hard template-synthesized porous carbons (500˜1200 m² g⁻¹). (Liu, R., Wu, D., Feng, X. & Mullen, K. Nitrogen-doped ordered mesoporous graphitic arrays with high electrocatalytic activity for oxygen reduction. Angew. Chem. Int. Ed. 49, 2565-2569 (2010); Liang, J., Jiao, Y., Jaroniec, M. & Qiao, S. Z. Sulfur and nitrogen dual-doped mesoporous graphene electrocatalyst for oxygen reduction with synergistically enhanced performance. Angew. Chem. Int. Ed. 51, 11496-11500 (2012); Yang, D.-S., Bhattacharjya, D., Inamdar, S., Park, J. & Yu, J.-S. Phosphorus-doped ordered mesoporous carbons with different lengths as efficient metal-free electrocatalysts for oxygen reduction reaction in alkaline media. I Am. Chem. Soc. 134, 16127-16130 (2012).) The more than doubled surface area of NPMC-1000 compared to that of NPMC-900 agrees well to the significant weight loss around that temperature shown in TGA-MS spectra (FIGS. 11 and 12a-12g due, most probably, to the generation of volatile species (CO, CO₂; see also Table 1, above) from carbonization of PANi aerogel. The type IV isotherm curves shown in FIG. 2a have an obvious hysteresis and confirm the existence of mesopores. The rapid nitrogen uptake (P/P₀>0.9) might be due to the presence of secondary, much larger pores. Barrett-Joyner-Halenda (BJH) pore size distribution curves derived from the N₂ desorption branches confirm the presence of mesopores with diameters<10 nm (FIG. 2b) and significantly enhanced pore volumes from 0.17 cm³ g⁻¹ for PANi aerogel to 0.50, 1.10, and 1.42 cm³ g⁻¹ for NPMC-900, NPMC-1000, and NPMC-1100 (Table 2, above), respectively. Overall, the data confirm that the one-step pyrolysis process produces NPMC samples with 3D mesoporous structures of a large surface area, high pore volume, and proper pore size for electrocatalytic applications.

During heat treatment, phytic acid exhibited a weight loss of ˜25% before 320° C., which could be attributed to the volatilization of physically and chemically absorbed water. The weight loss in the range of 300-600° C. suggests the decomposition of main phytic acid molecules. The continuous weight loss to 1000° C. is attributable to the further decarboxylation and graphitization with a residual amount of about 10%. The weight loss of PANi aerogel (˜20% wt) in the initial stage could also be attributed to volatilization of physically and chemical absorbed water by the polymer. (Gomes, E. C. & Oliveira, M. A. S. Chemical polymerization of aniline in hydrochloric acid (HC1) and formic acid (HCOOH) media. Differences between the two synthesized polyanilines. Am. J. Polymer Sci. 2, 5-13 (2012).) The weight loss between 320 and 750° C. arises from the thermal decomposition of the phytic acid interacted with the main molecular chain of PANi. The sharp weight loss for PANi aerogel was observed from 750 to 1000° C. (˜40% wt), over which most of the thermally stable and crosslinkable domains (e.g., benzene moieties) were finally transformed into carbon at the expense of alkyl chains and anions, especially from the large organic moleculeof phytic acid with low carbon content. Thus, micro/mesopores (FIGS. 13a and 13b) were formed by dehydrogenation, denitrogenation, or dephosphorization to produce decomposition gases (e.g., CO, CO₂), which exited from the residual carbons to generate pores/channels along their paths (Zhang, S., Miran, M. S., Ikoma, A., Dokko, K. & Watanabe, M. Protic ionic liquids and salts as versatile carbon precursors. J. Am. Chem. Soc. 136, 1690-1693 (2014)), and hence the significant loss of heteroatoms and sharply increased surface area (Table 2) with large amounts of edge-like structures observed from 900 to 1000° C. The single-step hard template-free method for the formation of porous carbon from the PANi aerogel is therefore robust to prepare highly porous N, P-doped carbons, which are expected to provide many active sites for electrocatalysis.

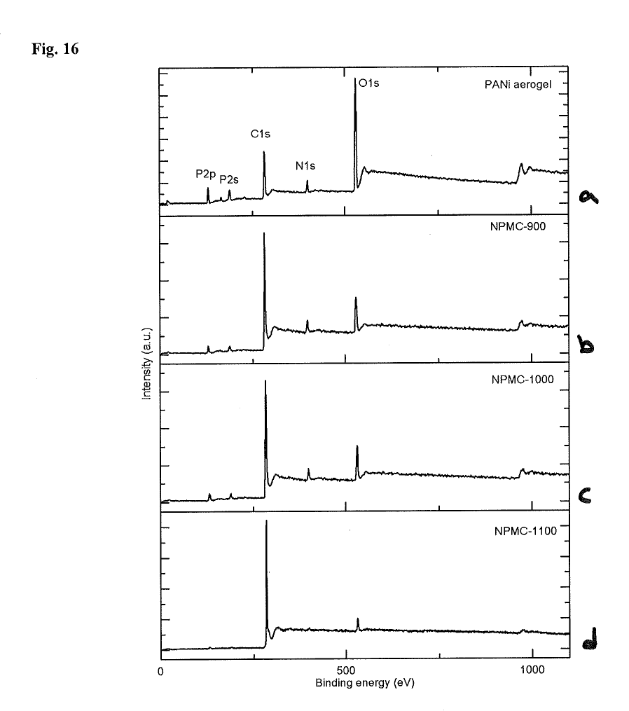

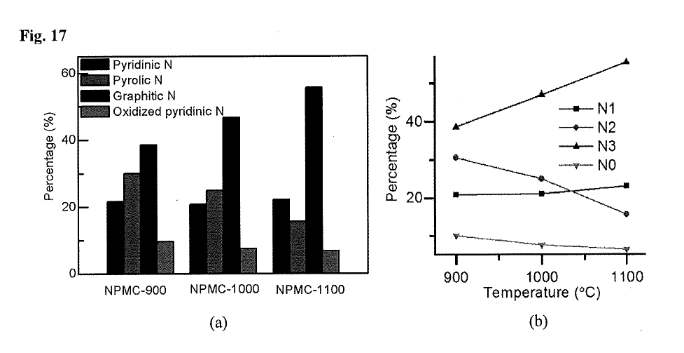

The typical X-ray photoelectron spectra (XPS) for NPMCs are given in FIGS. 16a and 16b with the numerical data summarized in Table 2, above. As expected, the XPS spectra show peaks for C, N, and P, along with an O peak resulted mainly from the phytic acid precursor (FIG. 1a). Nevertheless, the possibility for incorporation of physically adsorbed oxygen in NPMCs cannot be ruled out as the graphitic structure is known to be susceptible to oxygen absorption even at a low pressure. (Wang, S. et al. Vertically aligned BCN nanotubes as efficient metal-free electrocatalysts for the oxygen reduction reaction: A synergetic effect by co-doping with boron and nitrogen. Angew. Chem. Int. Ed. 50, 11756-11760 (2011).) The fitted XPS peaks for N is of PANi aerogel (FIG. 2c) centred at about 399.5 eV, 400.3 eV, and 401.6 eV are attributable to quinonoid imine (QI), benzenoid amine (BA), and nitrogen cationic (NC) radical, respectively. The presence of latter peak is indicative of the protonic doping of PANi by phytic acid. (Zhang, J., Jiang, J., Li, H. & Zhao, X. S. A high-performance asymmetric supercapacitor fabricated with graphene-based electrodes. Energy Environ. Sci. 4, 4009-4015 (2011).) The XPS Nls spectra for NPMC samples can be deconvoluted into four different bands at about 398.6, 400.5, 401.3, and 402.0 eV corresponding to pyridinic (N1), pyrrolic (N2), graphitic (N3), and oxidized pyridinic nitrogen (N0), respectively. (Ding, W. et al. Space-confinement-induced synthesis of pyridinic- and pyrrolic-nitrogen-doped graphene for the catalysis of oxygen reduction. Angew. Chem. Int. Ed. 52, 11755-11759 (2013).) These various nitrogen species would lead to different chemical/electronic environments for neighbour carbon atoms, and hence different electrocatalytic activities. The curve-fitting in FIG. 2c and the corresponding normalized results (FIGS. 17a and 17b) indicate a conversion from pyrrolic to graphitic nitrogen with increasing the temperature, in consistent with previous reports on N-doped carbon materials. (Su, F. et al. Nitrogen-containing microporous carbon nanospheres with improved capacitive properties. Energy Environ. Sci. 4, 717-724 (2011).) The P₂ₚ spectra (FIG. 2d) of PANi aerogel were deconvoluted into two different bands at about 132.9 (P1) and 133.8 eV (P2) corresponding to the core-levels of phosphorus atoms in phosphate species. (Cui, X. et al. Microstructure and corrosion resistance of phytic acid conversion coatings for magnesium alloy. Appl. Surf. Sci. 255, 2098-2103 (2008).) Upon heat treatment, NPMC-900 showed two similar component peaks with slight binding shift to lower energy, arising from gradual dehydration and condensation of phosphoric groups into polyphosphates, and the subsequent charge-transfer interaction of phosphorus with conjugated aromatic carbon rings to generate P—C (131.8 eV) and P—O (133.4 eV) bonds in NPMC-1000 and NPMC-1100. Gorham, J., Tones, J., Wolfe, G., d'Agostino, A. & Fairbrother, D. H. Surface reactions of molecular and atomic oxygen with carbon phosphide films. J. Phys. Chem. B 109, 20379-20386 (2005); Puziy, A. M., Poddubnaya, O. I., Socha, R. P., Gurgul, J. & Wisniewski, M. XPS and NMR studies of phosphoric acid activated carbons. Carbon 46, 2113-2123 (2008).) This suggests the successful doping of P heteroatoms into the carbon network through thermal pyrolysis. (Puziy, A. M., Poddubnaya, O. I., Socha, R. P., Gurgul, J. & Wisniewski, M. XPS and NMR studies of phosphoric acid activated carbons. Carbon 46, 2113-2123 (2008).) Further heating caused a gradual loss of the P—C peak due to the thermal decomposition of heteroatom dopants from the carbon matrix (Table 2, above), in consistent with the TGA and TGA-MS results (FIGS. 11 and 12a-12g). Thus, the pyrolysis temperature should be controlled to produce NPMCs with the desired mesopores as well as N and P contents.

FIGS. 17a and 17(b) both show a conversion from pyrrolic to the more stable graphitic nitrogen with increasing the pyrolysis temperature due to the instability of pyrrolic nitrogen, which is in consistent with previous reports on N-doped carbon nanomaterials. For the percentage content of pyridinic nitrogen, a small increase was observed with increasing pyrolysis temperature, but the tendency is not obvious. This is because more pores were generated with increasing the pyrolysis temperature to expose the edge-like pyridinic nitrogen for the XPS detection, which is counterbalanced by the N loss associated with high-temperature heating.

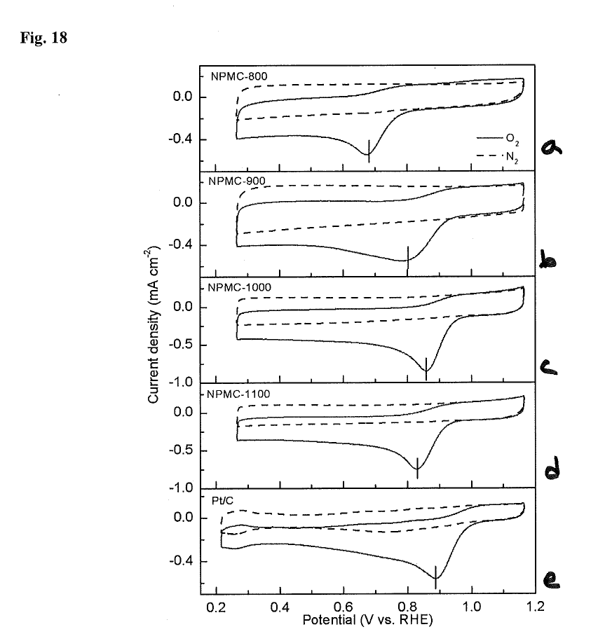

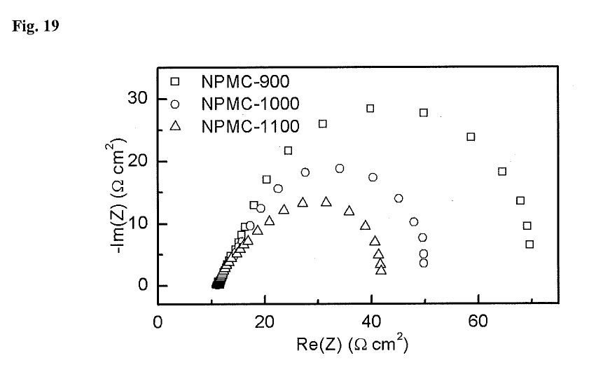

Electrochemical evaluation of NPMCs for ORR and OER. The cyclic voltammetry (CV) curves (FIGS. 18a-18e) exhibit oxygen reduction peaks for all of the NPMC electrodes in the O₂-saturated KOH solution, but not the N₂-saturated KOH solution. The observed oxygen reduction peak shifted to more positive potential with increasing pyrolysis temperature from 800 to 1000° C., but slightly reversed by further increasing the temperature up to 1100° C. The similar reduction potential to that of the commercial Pt/C catalyst (Pt/XC-72, 20 wt. %) was observed at the NPMC-1000 electrode, suggesting a high electrocatalytic activity of the metal-free NPMC catalyst. This is because pyrolysis at a higher temperature normally leads to a higher graphitization degree with a higher electrical conductivity (thus a lower charge-transfer resistance in FIG. 19), and hence a better electrocatalytic activity as from NPMC-900 to NPMC-1000. However, overheating (say from 1000 to 1100° C.) could cause decomposition of the dopants (Table 2, above), and hence the observed negative shift of the peak potential from NPMC-1000 to NPMC-1100. In addition, the current density follows the same trend (FIGS. 18a-18e), indicating once again that NPMC-1000 is more electrocatalytically active than both NPMC-900 and NPMC-1100.

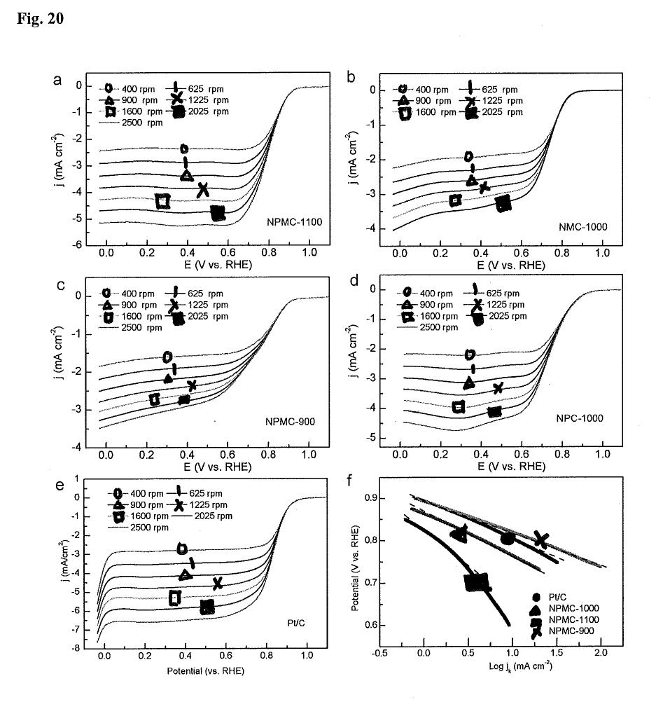

The linear scan voltammogram (LSV) curves in FIG. 3a confirm the electrocatalytic performance for NPMC-1000 with a positive onset potential of 0.94 V versus reversible hydrogen electrode (RHE) and a half-wave potential of 0.85 V vs. RHE. These values are comparable to those of Pt/C and outperform most previously-reported metal-free ORR catalysts (Yang, D.-S., Bhattacharjya, D., Inamdar, S., Park, J. & Yu, J.-S. Phosphorus-doped ordered mesoporous carbons with different lengths as efficient metal-free electrocatalysts for oxygen reduction reaction in alkaline media. J. Am. Chem. Soc. 134, 16127-16130 (2012); Yang, S., Feng, X., Wang, X. & Mullen, K. Graphene-based carbon nitride nanosheets as efficient metal-free electrocatalysts for oxygen reduction reactions. Angew. Chem. Int. Ed. 50, 5339-5343 (2011).) and even recently-reported carbon-based catalysts with metals. (Tian, G.-L. et al. Nitrogen-doped graphene/carbon nanotube hybrids: In situ frmation on bifunctional ctalysts and their superior electrocatalytic activity for oxygen evolution/reduction reaction. Small 10, 2251-2259 (2014); Zhao, Y., Watanabe, K. & Hashimoto, K. Self-supporting oxygen reduction electrocatalysts made from a nitrogen-rich network polymer. J. Am. Chem. Soc. 134, 19528-19531 (2012); Xiang, Z. et al. Highly efficient electrocatalysts for oxygen reduction based on 2D covalent organic polymers complexed with non-precious metals. Angew. Chem. Int. Ed. 53, 2433-2437 (2014).) Furthermore, the limiting current of the NPMC-1000 electrode is much larger than those of NPMC-900 and NPMC-1100, and comparable to that of Pt/C (FIG. 3a). Also included in FIG. 3a are the corresponding LSV curves for the purely N-doped mesoporous carbon (NMC-1000, Methods) and N and P doped carbon (NPC-1000, Methods), respectively. As can be seen in FIG. 3a, the NPMC-1000 has the highest electrocatalytic activity among all the aforementioned metal-free catalysts in terms of both the onset potential and limiting current, highlighting the importance of the N, P co-doping and the mesoporous structure for ORR. The electron transfer number per oxygen molecule (n) for ORR was determined from LSV curves (FIGS. 3b-3c and FIGS. 20a-20f) according to Koutechy-Levich (K-L) equation. The K-L plots (FIG. 3c) show linear relationships between jₖ⁻¹ and ω^{1/2} (jₖ is the kinetic current and ω is the electrode rotating rate) with a similar slope for the NPMC-1000 and Pt/C electrodes, from which n was determined to be ˜4.0, suggesting a four-electron pathway for ORR (Liu, R., Wu, D., Feng, X. & Mullen, K. Nitrogen-doped ordered mesoporous graphitic arrays with high electrocatalytic activity for oxygen reduction. Angew. Chem. Int. Ed. 49, 2565-2569 (2010); Zheng, Y., Jiao, Y., Ge, L., Jaroniec, M. & Qiao, S. Z. Two-step boron and nitrogen doping in graphene for enhanced synergistic catalysis. Angew. Chem. Int. Ed. 52, 3110-3116 (2013).) The kinetic current (jₖ) obtained from the intercept of the linearly fitted K-L plots at 0.7 V (vs. RHE) for the NPMC-1000 electrode is the largest among all the metal-free catalysts investigated in this study (FIG. 3d). Although the NPMC-900 sample has the highest N and P contents (Table 2, above), the relatively low pyrolysis temperature could lead to a high charge-transfer resistance (FIG. 19), and hence a relatively poor electrocatalytic activity. Although the electrical conductivity could be enhanced by increasing pyrolysis temperature, the doped heteroatoms would be removed (Table 2, above) resulting in reduced active sites and overall electrocatalytic activity, as exemplified by NPMC-1100 (FIG. 3a).

As shown in FIGS. 20a-20f, the Tafel curves of the NPMC and Pt/C catalysts, from which Tafel slopes were calculated to be ˜77 mV/decade for Pt/C, ˜89 mV per decade for NPMC-1000, ˜104 mV/decade for NPMC-1100, and ˜143 mV/decade for NPMC-900. As can be seen, the Tafel slope of NPMC-1000 is the lowest among all the NPMC catalysts and close to that of Pt/C, suggesting once again the high catalytic activity for ORR.

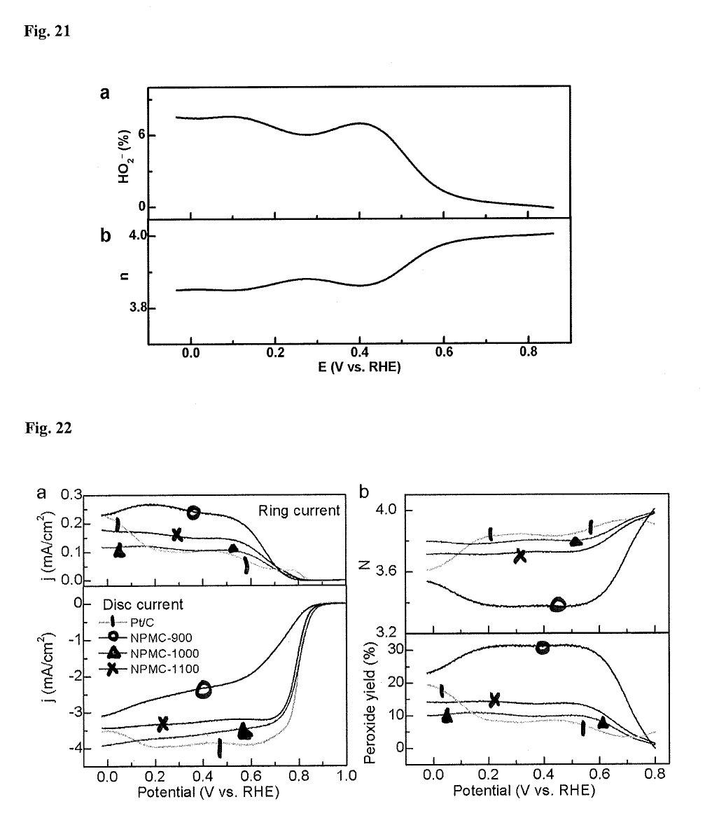

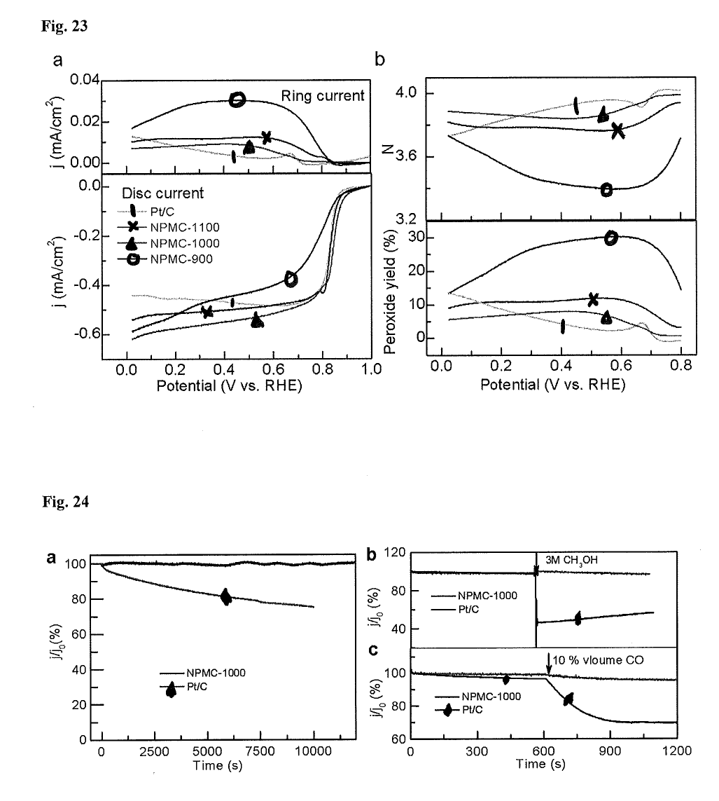

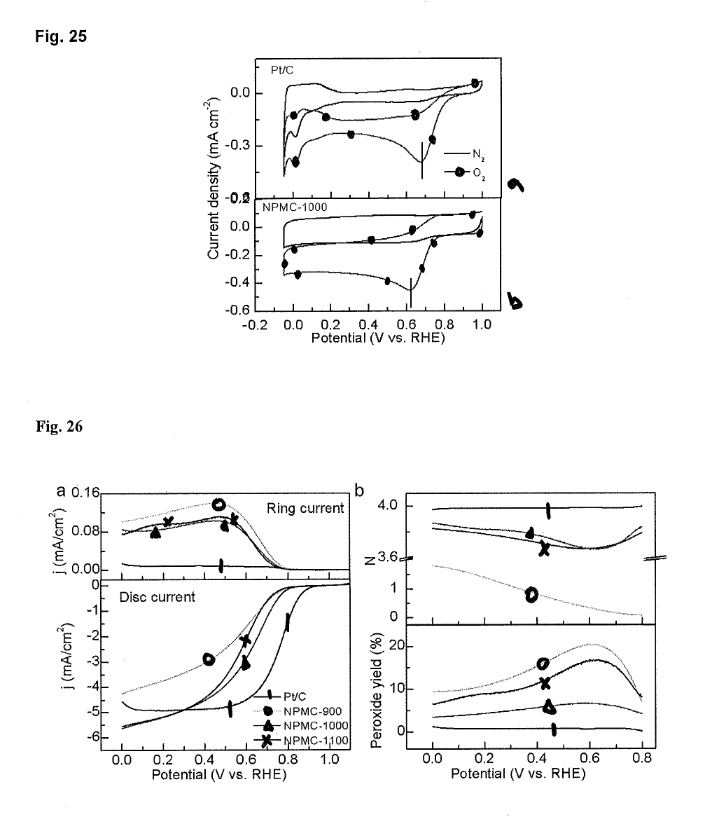

In order to further evaluate the ORR pathways for the NPMC-1000 electrode, the rotating ring-disk electrode (RRDE) measurements were obtained. As shown in FIG. 3e, the NPMC-1000 electrodes with two different mass loadings (150 and 450 μg cm⁻²) exhibited high disk current densities ˜4 and 6 mA cm⁻²) for O₂ reduction and much lower ring current densities (˜0.007 and 0.014 mA cm⁻²) for peroxide oxidation. Notably, the disk current could be significantly enhanced by increasing the mass loading and even become larger than that of Pt/C. FIG. 21a shows the percentage of peroxide species with respect to the total oxygen reduction products while FIG. 21b shows the electron transfer numbers calculated from the RRDE curves. It can be envisioned that oxygen molecules were reduced to water via a nearly four-electron pathway (n is over 3.85) with a small ratio of peroxide species (less than 8%). Similar good electrocatalytic activities were also observed for NPMC-1000 in 1 and 6 M KOH electrolytes, respectively (FIGS. 22a-22b and 23a-23b). In comparison with the Pt/C catalyst, the NPMC-1000 electrode exhibited better long-term stability, higher resistance to methanol cross-over effect and CO poisoning effect (FIGS. 24a-24c) in oxygen-saturated 0.1 M KOH, and comparable catalytic activity even in acidic electrolyte (FIGS. 25a-25b and 26a-26b). Since the activation energy of ORR on a catalyst is directly related to its catalytic activity (Jiao, Y., Zheng, Y., Jaroniec, M. & Qiao, S. Z. Origin of the electrocatalytic oxygen reduction activity of graphene-based catalysts: a roadmap to achieve the best performance. I Am. Chem. Soc. 136, 4394-4403 (2014); Li, M., Zhang, L., Xu, Q., Niu, J. & Xia, Z. N-doped graphene as catalysts for oxygen reduction and oxygen evolution reactions: Theoretical considerations. J. Catal. 314, 66-72 (2014)), the first-principles methods was used to calculate the activation energy of ORR elemental steps in acidic and alkaline environments. As depicted in Table 3, below, among the five barriers in acidic media, H₂O formation in the last step of ORR has the highest value (0.66 eV), and therefore is the rate-limiting step for ORR, which is much smaller than that of Pt(111) surface (1.22 eV) (Sha, Y., Yu, T. H., Liu, Y., Merinov, B. V. & Goddard, W. A. Theoretical study of solvent effects on the platinum-catalyzed oxygen reduction reaction. J. Phys. Chem. Letters 1, 856-861 (2010)).

As shown in FIG. 24a, a large current decrease for oxygen reduction (˜30%) at Pt/C electrode was observed upon the addition of 3 M CH₃OH. In contrast, no change on the current was observed at the NPMC-1000 electrode, suggesting the extreme stability for ORR at the NPMC-1000 electrode. The current-time curves in FIG. 24b illustrate that the oxygen reduction current at Pt/C electrode sharply decreases by about 50% upon the addition of methanol, showing a serious negative crossover effect. These results suggest that NPMC has a higher selectivity toward ORR than that of Pt/C. Additionally, CO was added in the electrolyte in order to measure the CO poisoning effect. As shown in FIG. 24c, a large current decrease for oxygen reduction (˜30%) at Pt/C electrode was observed. Notably, no big change on the current was observed at the NPMC-1000 electrode. The results suggest that NPMC-1000 has better resistance to CO poisoning effect in comparison with Pt/C.

TABLE 3
The activation energies (Eₐ) and free energies (ΔG) for elemental
steps involved in ORR on N, P doped graphene in associative mechanism
in acidic media, and Langmuir-Hinshelwood mechanism (Zhang, P., Xiao,
B. B., Hou, X. L., Zhu, Y. F., Jiang, Q. Layered SiC Sheets: A Potential
Catalyst for Oxygen Reduction Reaction, Sci. Rep., 4, 3821(2014))
in alkaline electrolyte.

| Solutions | Reaction equations | Eₐ (eV) | Δ(eV) |
|---|---|---|---|
| Acid | O₂ + * → O₂* | 0.03 | 0.0512 |
| | O₂* + H + e → OOH* | 0.38 | −0.824 |
| | OOH* + H + e → O* + H₂O | 0.22 | −1.5619 |
| | O* + H + e → OH* | 0.03 | −1.8336 |
| | OH* + H + e → * + H₂O | 0.66 | −0.751 |
| Alkaline | O₂ + * → O₂* | 0.03 | 0.0512 |
| | O₂* + H₂O + 2e → O* + 2OH⁻ | ~0.30 | −0.729 |
| | O* + H₂O + 2e → * + 2OH⁻ | ~0.50 | −0.939 |

*refers to an active site on graphene catalyst.

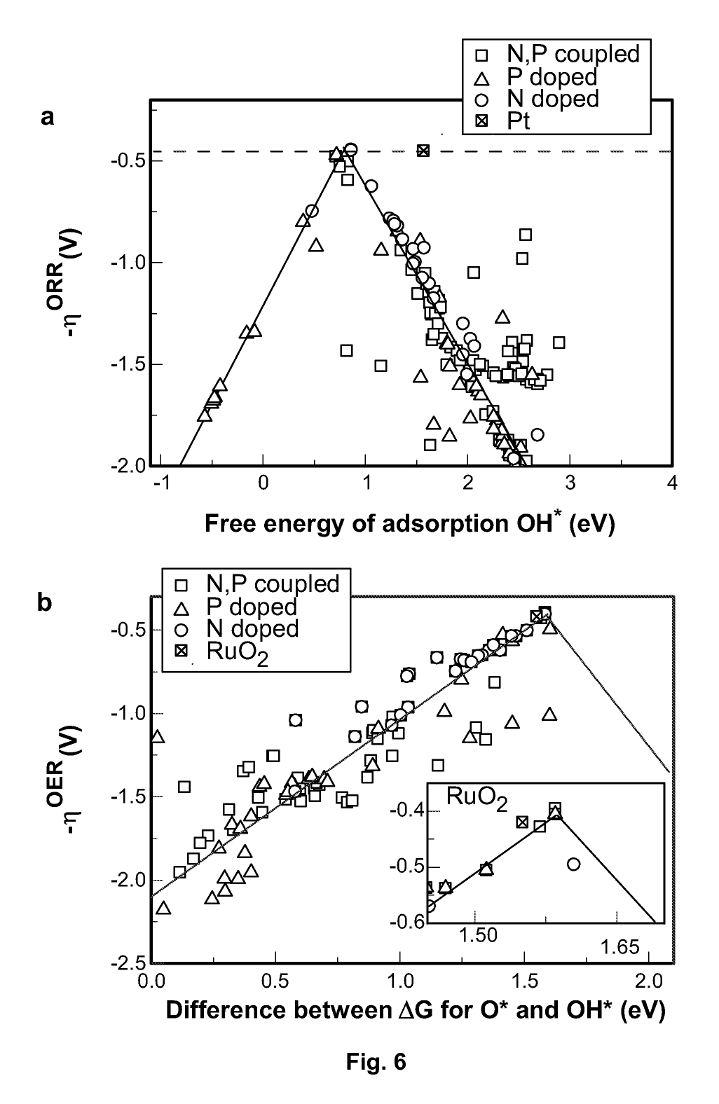

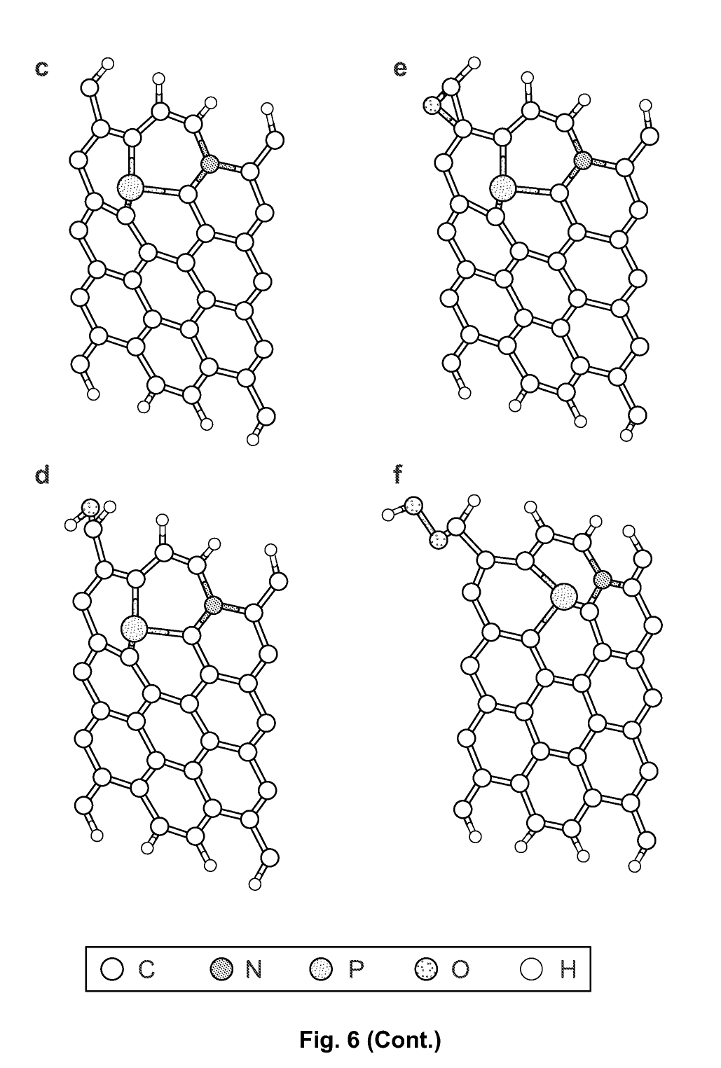

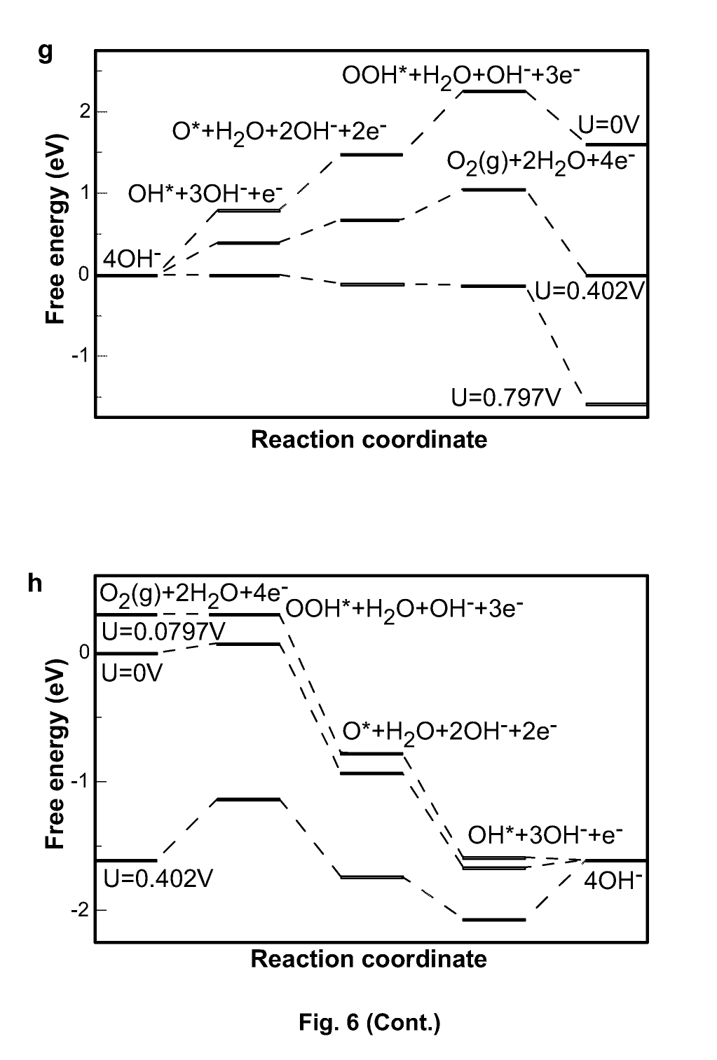

In the alkaline media, the calculated activation energy of the rate-limiting step of Langmuir-Hinshelwood mechanism is ˜0.5 eV for N, P co-doped graphene, while the activation energies for N-doped graphene and on Pt(111) surface are ˜0.56-0.62 eV and 0.55 eV, respectively. (Sha, Y., Yu, T. H., Liu, Y., Merinov, B. V. & Goddard, W. A. Theoretical study of solvent effects on the platinum-catalyzed oxygen reduction reaction. J. Phys. Chem. Letters 1, 856-861 (2010); Yu, L., Pan, X., Cao, X., Hu, P. & Bao, X. Oxygen reduction reaction mechanism on nitrogen-doped graphene: A density functional theory study. J. Catal. 282, 183-190 (2011).) The calculations reported in FIG. 6 also reveal that NPMCs possess ORR activities comparble to, or even better than, that of Pt in alkaline media. Thus, the N, P co-doped carbon could show high catalytic activities in both acidic and alkaline environments.

FIGS. 25a-25b depict the reduction peak for oxygen reduction at the NPMC-1000 electrode is located about 0.62 V (vs. RHE), which is only 60 mV negative in composition with Pt/C, suggesting the comparable catalytic activity towards ORR in acidic electrolyte. According to the RRDE results (FIG. 26a), the oxygen reduction occurred at about 0.83 V for the NPMC-1000 electrode. More importantly, the electron transfer number is over 3.8 and less than 8% H₂O₂ was generated during the oxygen reduction process at the NPMC-1000 electrode. These results suggest that most O₂ were directly reduced to water via a four-electron pathway even in the acidic medium.

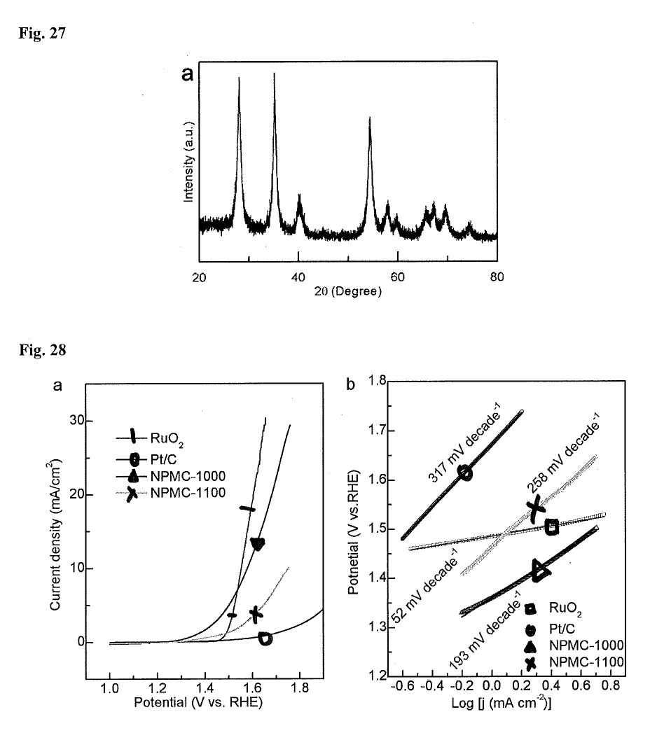

FIG. 3f shows the rapidly increased anodic current above ˜1.30 V associated with OER. The good OER catalytic activities for NPMCs were reflected by their lower onset potentials and higher currents than those of the Pt/C electrode (FIG. 30. The state-of-the-art OER electrode based on RuO₂ nanoparticles (FIG. 27) was used as reference (Man, I. C. et al. Universality in oxygen evolution electrocatalysis on oxide surfaces. ChemCatChem 3, 1159-1165 (2011)) and found that the NPMC-1000 also exhibited a lower onset potential than that of RuO₂ nanoparticles, along with slightly lower current densities at higher potentials (FIG. 3f and FIGS. 28a-28b in 6 M KOH).

The results depcited in FIGS. 28a and 28b indicate that NPMC-1000 can enhance the oxygen evolution with a small overpotential. In comparison with Pt/C and NPMC-1100, the smaller slope suggests the better kinetic process for ORR at NPMC-1000. Furthermore, the NPMC-1000 also exhibited a lower onset potential than that of RuO₂ nanoparticles, indicating good OER performance even comparing with RuO₂.

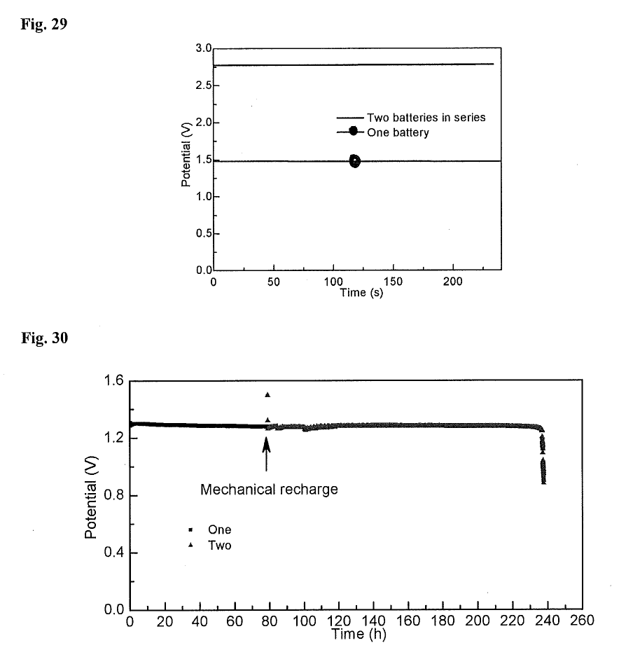

The NPMC material may be used as the air cathode in primary Zn-air battery. Bifunctional catalysts for both ORR and OER are highly desirable for rechargeable Zn-air battery application. To this end, the possibility of NPMC as metal-free bifunctional catalysts was examined. A primary Zn-air battery was constructed by using NPMC as electrocatalyst (FIG. 4a). The open circuit potential (OCP) of the two-electrode primary Zn-air battery is as high as ˜1.48 V (FIG. 29), suggesting a good catalytic performance of NPMC-1000 even in the cell configuration. FIG. 4b shows the polarization and power density curves for Zn-air batteries based on the NPMC air cathodes. Among all of the NPMC cathodes, the NPMC-1000 catalyst showed a current density of ˜70 mA cm⁻² and a peak power density of ˜55 mW cm², comparable to those of a Pt/C catalyst (˜60 mA cm⁻² and 50 mW cm⁻²). The good performances of the NPMC-1000 foam derive from its porous structure that facilitates an efficient diffusion of O₂ gas and electrolyte to the active sites. When normalized to the mass of consumed Zn, the specific capacity of the battery was over 735 mAh g_{Zn}⁻¹ (corresponding to an energy density of ˜835 Wh kg_{Zn}⁻¹) at a current density of 5 mA cm⁻², which corresponds to about 89.6% utilization of the theoretical capacity (˜820 mAh g_{Zn}⁻¹) (Kraytsberg, A. & Ein-Eli, Y. The impact of nano-scaled materials on advanced metal-air battery systems. Nano Energy 2, 468-480 (2013).) (FIG. 4c). When the current density is increased to 25 mA cm⁻², the specific capacity of the battery was ˜689 mAh g_{Zn}⁻¹ (corresponding to an energy density of ˜675 Wh kg_{Zn}⁻¹). These values are higher than those of Zn—O₂ batteries that use metal-oxide-based CoO/CNT catalyst (˜570 Wh kg_{Zn}⁻¹ at 10 mA cm⁻²). (Li, Y. et al. Advanced zinc-air batteries based on high-performance hybrid electrocatalysts. Nature Commun. 4, 1805 (2013).) Notably, the potential of battery using NPMC-1000 (˜1.26 V) at the current density of 5 mA cm⁻² is also higher than batteries using Pt/C (˜1.16 V). Furthermore, no significant potential drop was observed when galvanostatic discharged for 30 h at 5 mA cm⁻² and 14 h at 20 mA cm⁻² (FIG. 4d), indicating a good catalytic stability for ORR. Although Zn is gradually consumed during the discharging process, the battery can be mechanically recovered by refilling Zn plate and KOH electrolyte. Typically, the battery can keep working over 240 h with almost no potential decrease in two cycles (FIG. 30), comparing favourably with most other recently reported primary Zn-air batteries (Table 4, below).

TABLE 4
The performance of primary Zn-air batteries with various electrocatalysts.

| | Mass | Peak power | Specific | | |
|---|---|---|---|---|---|
| | loading | density | capacity | Durability | |
| Electrocatalysts | (mg cm⁻²) | (mA cm⁻²) | (mA h g_{Zn}⁻¹) | (h) | Ref. |
| NPMC-1000 | 0.5 | ~55 | ~735 | 240 (~1.3 V) | This work |
| FePc-Py-CNTs | 0.6 | — | — | 100 (~1.2 V) | Ref. 1 |
| N doped graphene | 0.7 | ~42 | — | — | Ref. 2 |
| Porous N doped | — | ~70 | ~400 | — | Ref. 3 |
| graphene | | | | | |
| N, B doped CNT | — | ~25 | — | 30 (~1.1 V) | Ref. 4 |
| Nafion/PbMnOₓ | 100 | ~40 | — | 50 (~1.2 V) | Ref. 5 |
| Ag/C | 30 | ~34 | — | — | Ref. 6 |
| MnO₂/Co₃O₄ | 2 | ~36 | — | — | Ref. 7 |
| NiCo₂O₄ | — | — | ~580 | 10 (~1.25 V) | Ref. 8 |
| CoO/N-CNT^{a} | 1.0 | ~265 | ~570 | — | Ref. 9 |

^{a}The performance was measured in a beaker-type Zn—O₂ cell with humidified O₂ flow.
Ref. 1 Cao, R. et al. Promotion of oxygen reduction by a bio-inspired tethered iron phthalocyanine carbon nanotube-based catalyst. Nature Commun. 4, 2076 (2013).
Ref. 2 Lee, D. U., Park, H. W., Higgins, D., Nazar, L. & Chen, Z. Highly active graphene nanosheets prepared via extremely rapid heating as efficient zinc-air battery electrode material. J. Electrochem. Soc. 160, F910-F915 (2013).
Ref. 3 Sun, Y., Li, C. & Shi, G. Nanoporous nitrogen doped carbon modified graphene as electrocatalyst for oxygen reduction reaction. J. Mater. Chem. 22, 12810-12816 (2012).
Ref. 4 Liu, Y. et al. Boron and nitrogen codoped nanodiamond as an efficient metal-free catalyst for oxygen reduction reaction. J. Phys. Chem. C 117, 14992-14998 (2013).
Ref. 5 Yang, T.-H., Venkatesan, S., Lien, C.-H., Chang, J.-L. & Zen, J.-M. Nafion/lead oxide-manganese oxide combined catalyst for use as a highly efficient alkaline air electrode in zinc-air battery. Electrochim. Acta 56, 6205-6210 (2011).
Ref. 6 Han, J.-J., Li, N. & Zhang, T.-Y. Ag/C nanoparticles as an cathode catalyst for a zinc-air battery with a flowing alkaline electrolyte. J. Power Sources 193, 885-889 (2009).
Ref. 7 Du, G. et al. Co₃O₄ nanoparticle-modified MnO₂ nanotube bifunctional oxygen cathode catalysts for rechargeable zinc-air batteries. Nanoscale 5, 4657-4661 (2013).
Ref. 8 Prabu, M., Ketpang, K. & Shanmugam, S. Hierarchical nanostructured NiCo₂O₄ as an efficient bifunctional non-precious metal catalyst for rechargeable zinc-air batteries. Nanoscale 6, 3173-3181 (2014).
Ref. 9 Li, Y. et al. Advanced zinc-air batteries based on high-performance hybrid electrocatalysts. Nature Commun. 4, 1805 (2013).

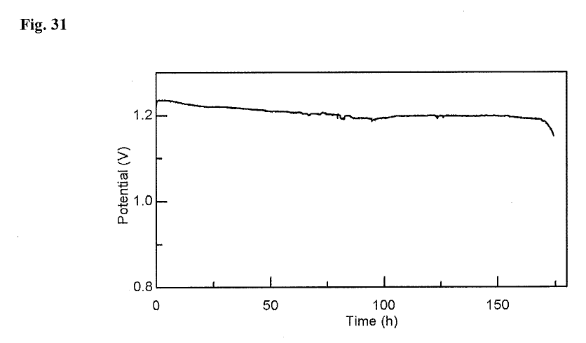

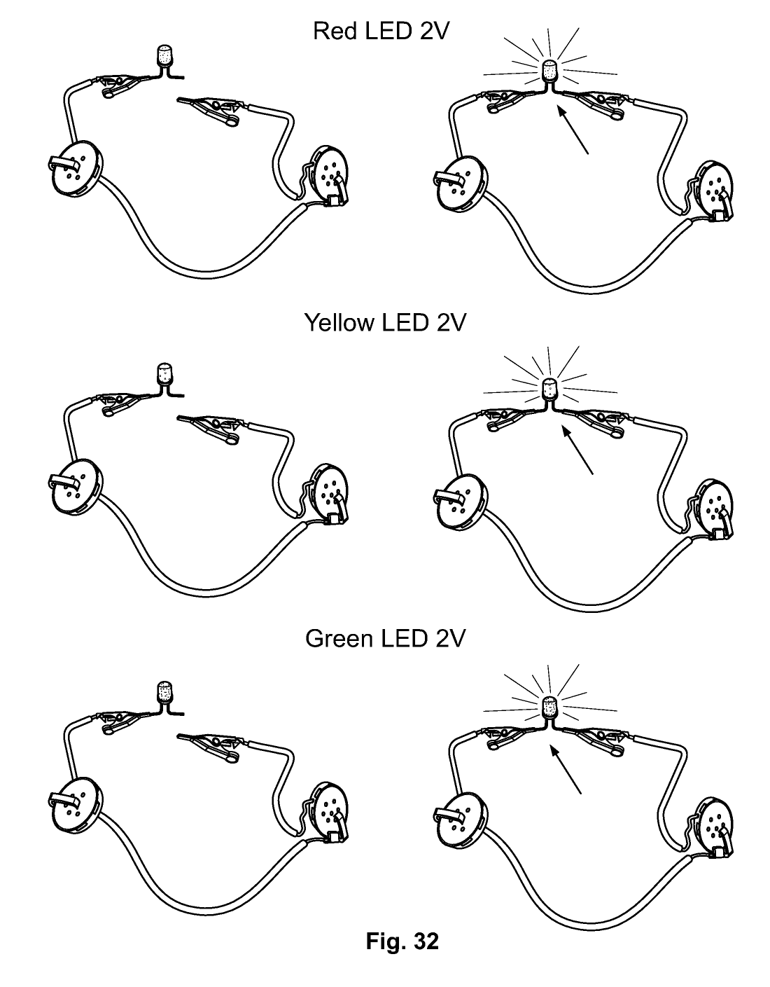

The battery can be mechanically charged up for many cycles (FIG. 4e). The Zn-air battery can also be operated in KOH electrolyte at lower concentration (1.0 M KOH) with an excellent durability (FIG. 31). To meet specific energy and/or power needs for various practical applications, multiple Zn-air batteries can be integrated into series circuits. As exemplified in FIG. 29, two Zn-air button batteries were connected in series to generate a sufficiently high OCP of ˜2.8 V to power different light-emitting diodes (LEDs) (FIG. 4f and FIG. 32).

The observed sudden drop in voltage at 0 hour was caused by a sudden increase in current density after resting the battery at the open circuit potential without current loading for the testing. The battery is mechanically rechargable. FIG. 4e shows the durability of a primary zinc-air battery. The Zinc and electrolyte were mechanically replaced at the point where the color of the curve changes (One, Two, Three, and Four in FIG. 4e represent the 1st, 2nd, 3rd, and 4th charge cycle, respectively). The color dots above the potential vs. time curve were resulted from the open circle potential by opening the battery for each mechanical recharge. FIG. 4f shows optical images of an LED before and after being driven by two zinc-air bateries in series.

The NPMC materal may also be used as the air cathode in rechargeable Zn-air battery. In a rechargeable Zn-air battery, the kinetics is mainly limited by the cathode reaction:

$${O}_{2} + 2 {H}_{2} O + 4 {e}^{-} {{⇄}_{OER}}^{ORR} 4 {OH}^{-} .$$

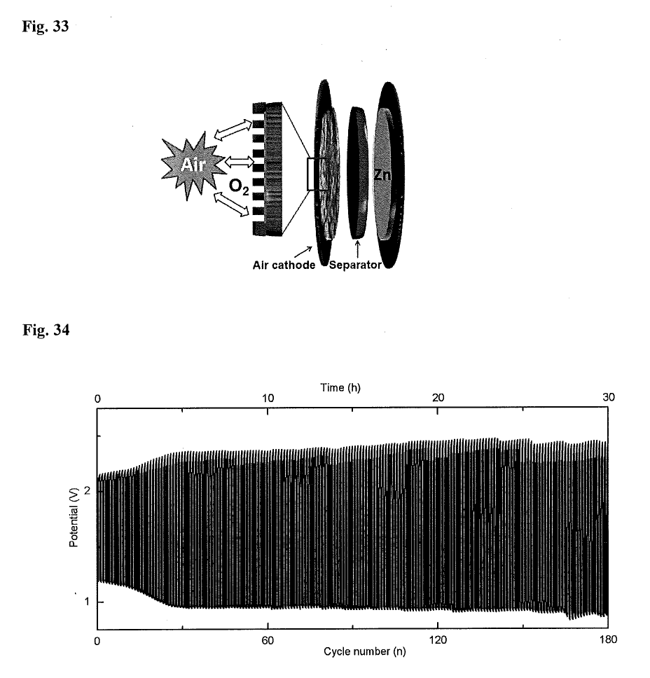

(Kraytsberg, A. & Ein-Eli, Y. The impact of nano-scaled materials on advanced metal-air battery systems. Nano Energy 2, 468-480 (2013).) A two-electrode rechargeable Zn-air battery that uses NPMC-1000 as a bifunctional catalyst (FIG. 33) shows a good recharge-ability as evidenced by 180 discharge/charge cycles for 30 h (FIG. 5a), which is better than those of a Zn-air battery using core-corona structured bifunctional catalyst with lanthanum nickelate centers supporting nitrogen-doped carbon nanotubes (75 cycles for 12.5 h) (Chen, Z. et al. Highly active and durable core-corona structured bifunctional catalyst for rechargeable metal-air battery application. Nano Letters 12, 1946-1952 (2012)) and MnO₂/Co₃O₄ hybrid (60 cycles for 14 h) catalyst (Du, G. et al. Co₃O₄ nanoparticle-modified MnO₂ nanotube bifunctional oxygen cathode catalysts for rechargeable zinc-air batteries. Nanoscale 5, 4657-4661 (2013)), respectively. Considering the relatively poor catalytic activity of Pt/C for OER, a reference two-electrode Zn-air battery using the mixed Pt/C and RuO₂ as the bifunctional electrocatalyst for ORR and OER was constructed for comparison (FIG. 34). Compared with FIG. 5a, FIG. 34 exhibited a lower charging potential, indicating a relatively high catalytic activity towards OER.

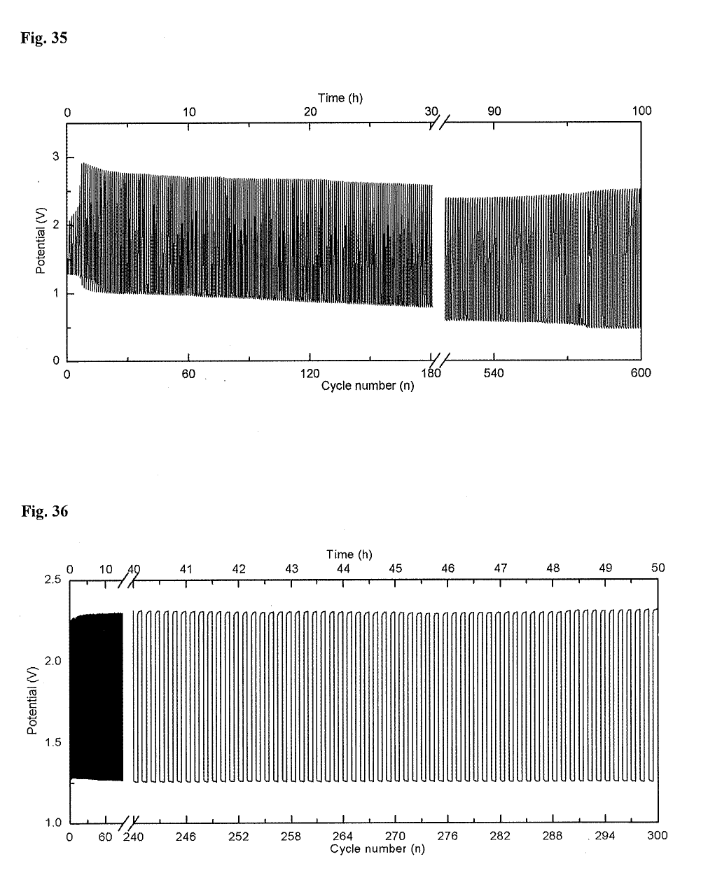

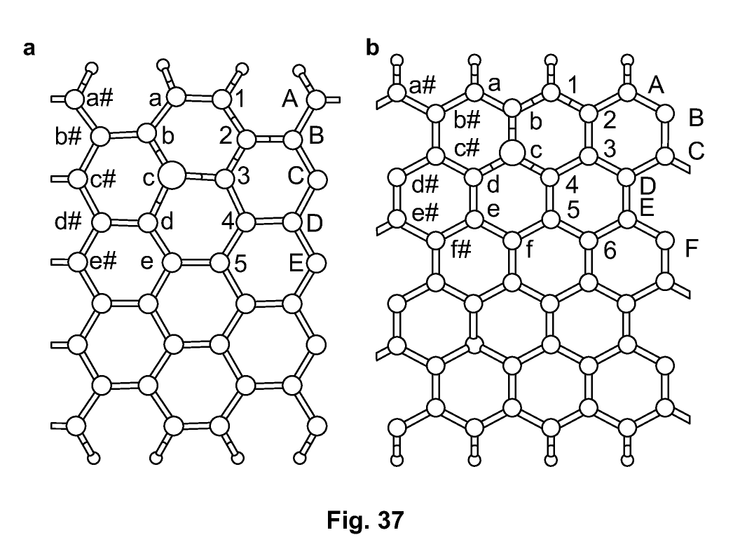

Although NPMC-1000 accelerates both ORR and OER, a certain degree of irreversibility is unavoidable due to the different catalytic activities of the same catalyst toward ORR and OER reactions. Consequently, a deteriorating performance was observed for the two-electrode rechargeable Zn-air battery during long-term cycling test (FIG. 35). (Chen, Z. et al. Highly active and durable core-corona structured bifunctional catalyst for rechargeable metal-air battery application. Nano Letters 12, 1946-1952 (2012).) However, the catalytic activity of NPMC can be improved by optimizing the pore structure, heteroatom doping site, electrode surface chemistry, and cell configuration. Indeed, the NPMC battery performance was significantly enhanced by using an optimized three-electrode configuration (FIG. 5b) that prevents the bifunctional catalyst to come in contact with the oxidative (or reductive) potential during ORR (or OER). In this case, the activities toward ORR and OER could be independently regulated by adjusting the catalyst mass loading on each of the two air electrodes (Li, Y. et al. Advanced zinc-air batteries based on high-performance hybrid electrocatalysts. Nature Commun. 4, 1805 (2013); Toussaint, G., Stevens, P., Akrour, L., Rouget, R. & Fourgeot, F. Development of a rechargeable zinc-air battery. ECS Transactions 28, 25-34 (2010)) and a balanced reversible transfer between oxygen reduction and evolution was readily achieved. FIG. 5c shows the discharge and charge polarization curves for the three-electrode batteries with various air electrodes. The three-electrode rechargeable Zn-air battery using the NPMC-1000 as the air electrodes showed no obvious voltage change over 600 discharge/charge cycles (for 100 h, FIG. 5d), comparable to that of three-electrode Zn-air battery using Pt/C and RuO₂ as the ORR and OER catalysts, respectively (FIG. 36). As shown in Table 5, below, the battery is comparable to, or even better than, most of the recently reported rechargeable Zn-air batteries based on metal/metal oxide electrodes. (Li, Y. et al. Advanced zinc-air batteries based on high-performance hybrid electrocatalysts. Nature Commun. 4, 1805 (2013); Lee, D. U., Choi, J.-Y., Feng, K., Park, H. W. & Chen Z. Advanced Extremely Durable 3D Bifunctional Air Electrodes for Rechargeable Zinc-Air Batteries. Adv. Energy Mater. 4, 1301089 (2014); Chen, S., Duan, J., Ran, J., Jaroniec, M. & Qiao, S. Z. N-doped graphene film-confined nickel nanoparticles as a highly efficient three-dimensional oxygen evolution electrocatalyst. Energy Environ. Sci. 6, 3693-3699 (2013).)

TABLE 5
The performance of rechargable Zn-air batteries with various electrocatalysts.

| Electrocatalysts | Recharge-ability | Ref. |
|---|---|---|
| Tri-electrode: NPMC-1000 | 600 s/cycle for 600 cycles (100 h) | This work |
| Two-electrode: NPMC-1000 | 600 s/cycle for 180 cycles (30 h) | This work |
| B,N co-doped CNT | 600 s/cycle for 80 cycles (~13.3 h) | Ref. 4 |
| MnO₂/Co₃O₄ | 840 s/cycle for 60 cycles (14 h) | Ref. 7 |
| NiCo₂O₄ | 600 s/cycle for 50 cycles (~8.2 h) | Ref. 8 |
| Tri-electrode: CoO/N-CNT + NiFe | 4-20 h/cycle for >200 h | Ref. 9 |
| LDH/Ni ^{a} | | |
| MnO₂/CNT | 600 s/cycle for 50 cycles (~8.2 h) | Ref. 10 |
| LaNiO₃ supported on N-CNTs | 600 s/cycle for 75 cycles (12.5 h) | Ref. 11 |
| Ag—MnO₂ | 1200 s/cycle for 270 cycles (90 h) | Ref. 12 |
| Tri-electrode: MnO₂ + stainless steel | 24-30 h/cycle for ~120 h | Ref. 13 |
| CoMn₂O₄/N-reduced graphene oxide | 600 s/cycle for 100 cycles (16.7 h) | Ref. 14 |
| Co₃O₄ nanowires grown on | 600 s/cycle for 600 cycles (100 h) | Ref. 15 |
| stainless steel mesh | 6 h/cycle for 100 cycles (600 h) | |
| Co₃O₄ decorated carbon nanofiber | 1 h/cycle for 135 cycles (135 h) | Ref. 16 |

^{a} The performance was measured in a beaker-type Zn—O₂ cell with humidified O₂ flow.
Ref. 4 Liu, Y. et al. Boron and nitrogen codoped nanodiamond as an efficient metal-free catalyst for oxygen reduction reaction. J. Phys. Chem. C 117, 14992-14998 (2013).
Ref. 7 Du, G. et al. Co₃O₄ nanoparticle-modified MnO₂ nanotube bifunctional oxygen cathode catalysts for rechargeable zinc-air batteries. Nanoscale 5, 4657-4661 (2013).
Ref. 8 Prabu, M., Ketpang, K. & Shanmugam, S. Hierarchical nanostructured NiCo₂O₄ as an efficient bifunctional non-precious metal catalyst for rechargeable zinc-air batteries. Nanoscale 6, 3173-3181 (2014).
Ref. 9 Li, Y. et al. Advanced zinc-air batteries based on high-performance hybrid electrocatalysts. Nature Commun. 4, 1805 (2013).
Ref. 10 Chen, Z. et al. Manganese dioxide nanotube and nitrogen-doped carbon nanotube based composite bifunctional catalyst for rechargeable zinc-air battery. Electrochim. Acta 69, 295-300 (2012).
Ref. 11 Chen, Z. et al. Highly active anddurable core-corona structured bifunctional catalyst for rechargeable metal-air battery application. Nano Letters 12, 1946-1952 (2012).
Ref. 12 Goh, F. W. T. et al. Ag nanoparticle-modified MnO₂ nanorods catalyst for use as an air electrode in zinc-air battery. Electrochim. Acta 114, 598-604 (2013).
Ref. 13 Toussaint, G., Stevens, P., Akrour, L., Rouget, R. & Fourgeot, F. Development of a rechargeable zinc-air battery. ECS Transactions 28, 25-34 (2010).
Ref. 14 Prabu, M., Ramakrishnan, P. & Shanmugam, S. CoMn₂O₄ nanoparticles anchored on nitrogen-doped graphene nanosheets as bifunctional electrocatalyst for rechargeable zinc-air battery. Electrochem. Commun. 41, 59-63 (2014).
Ref. 15 Lee, D. U., Choi, J.-Y., Feng, K., Park, H. W. & Chen Z. Advanced Extremely Durable 3D Bifunctional Air Electrodes for Rechargeable Zinc-Air Batteries. Adv. Energy Mater. 4, 1301089 (2014).
Ref. 16 Li, B. et al. Co₃O₄ nanoparticles decorated carbon nanofiber mat as binder-free air-cathode for high performance rechargeable zinc-air batteries. Nanascale 7, 1830-1838 (2015).

Mechanism study on ORR and OER of bifunctional NPMCs. In order to gain further insights into the ORR and OER catalytic mechanisms of NPMC, first-principles calcultions were performed using the density functional theory (DFT) methods, to determine the electronic structures and catalytic reactions for the N, P co-doped carbon structures (FIG. 6). For the co-doped structure, N and P may exist on graphene in different forms, such as the isolated N-dopant, the isolated P-dopant, and/or the N—C—P coupled dopants (doping with N and P close to each other). To study the ORR/OER catalytic activities of these structures, all possible types of doping structures were built as shown in FIG. 37. Furthermore, the doping positions in each of the structures were changed with respect to the graphene edge to reveal the effect of doping sites. The possible ORR and OER pathways on N, P co-doped graphene are listed in Equations S1-S13. Since the overpotential (11) of ORR/OER is an important measure of catalytic activities of a catalyst (Norskov, J. K. et al. Origin of the overpotential for oxygen reduction at a fuel-cell cathode. J. Phys. Chem. B 108, 17886-17892 (2004)), the overpotential for each active site on the doped structures was calculated and the minimum overpotential for ORR and OER was determined. An ideal catalyst should be able to facilitate ORR and OER just above the equilibrium potential, with zero overpotential. However, the ideal case cannot be achieved because the binding energies of the intermediates are correlated. (Id.) Thus, thermodynamically, the lower overpotential indicates the better catalyst. FIGS. 6a-b shows volcano plots, that is the overpotential versus descriptors for various reaction sites on N, P co-doped graphene structures in alkaline environments. From this theoretical analysis, the isolated N-doped, isolated P-doped, and N—C—P coupled structures were identified to have minimum ORR overpotentials of 0.44 V, 0.47 V and 0.47 V, respectively; whereas the lowest OER overpotentials for these structures are 0.41 V, 0.49 V, and 0.39 V, respectively. Note that the N—C—P coupling gives the best OER performance while ORR overpotential could reach as low as 0.44 V based on the estimate of the volcano plot (FIG. 6a). Overall, the minimum overpotential of N,P co-doped graphene for ORR and OER are 0.44 V and 0.39 V, respectively, lower than those of the best catalysts identified theoretically (˜0.45 V for ORR on Pt (Nørskov, J. K. et al. Origin of the overpotential for oxygen reduction at a fuel-cell cathode. J. Phys. Chem. B 108, 17886-17892 (2004)) and ˜0.42 V for OER on RuO₂ (Man, I. C. et al. Universality in oxygen evolution electrocatalysis on oxide surfaces. ChemCatChem 3, 1159-1165 (2011))), indicating that the bifunctional N, P co-doped graphene catalyst could outperform its metal/metal oxide counterparts. Clearly, the N and P co-doping generates synergistic effects for improving electrocatalytic activities towards both OER and ORR.

For OER, the most active structure was identified to be the N—C—P coupled graphene shown in FIG. 6c with the active site located at the edge of the graphene. The elementary reactions of OER over the graphene in alkaline environment are shown in FIGS. 6d-f For the active sites on this graphene, the OER is uphill when the electrode potential is 0 V, but when the potential increases to 0.797 V (0.395 V in overpotential), all the elementary reaction steps become downhill, and OER occurs spontaneously over 0.797 V (FIG. 6g). Since the OER overpotential is reduced by the co-doping, the OER is facilitated overall by the N,P co-doped graphene. Similar phenomena were observed for ORR, but the reaction active sites were different from those in OER, though they are also located near the graphene edges. (Bao, X. et al. A first-principles study of the role of quaternary-N doping on the oxygen reduction reaction activity and selectivity of graphene edge sites. Top. Catal. 56, 1623-1633 (2013).) The most active site was identified to be N-dopant and elementary reaction pathways were detailed for N-doped graphene in previous papers. (Li, M., Zhang, L., Xu, Q., Niu, J. & Xia, Z. N-doped graphene as catalysts for oxygen reduction and oxygen evolution reactions: Theoretical considerations. J. Catal. 314, 66-72 (2014); Zhang, L. & Xia, Z. Mechanisms of oxygen reduction reaction on nitrogen-doped graphene for fuel cells. J. Phys. Chem. C 115, 11170-11176 (2011).) For ORR, the most active site is also located at the edge, and the elementary reactions and energy change are shown in FIG. 6h. OOH formation is rate-determining step of ORR and endothermic at alkaline media under a voltage of 0.402 V. At zero external potential, all the reactions are downhill, except fort the O₂ adsorption with a small energy barrior of 0.0797 eV. Overall, the distance of the doping sites from the graphene edge seems critical to the adsorption of chemical species and catalytic activities. In most cases, OER and ORR usually occur near the edge of the graphene but at different sites.

The present technology provides a low-cost and scalable approach to prepare three-dimensional mesoporous carbon foams co-doped with N and P (NPMCs). The co-doped foams may be prepared by pyrolyzing polyaniline aerogels obtained from a template-free polymerization of aniline in the presence of phytic acid. The resultant NPMCs show efficient catalytic activities for both ORR and OER as bifunctional air electrodes in primary and rechargeable Zn-air batteries. Typically, a primary Zn-air battery based on the NPMC metal-free air electrode operating in ambient air with aqueous KOH electrolyte exhibited a high open circuit potential (˜1.48 V), large energy density (˜835 Wh kg_{Zn}⁻¹) and peak power density (˜55 mW cm⁻²), as well as excellent durability (over 240 h after recycling two times in primary battery while it can be recharged for many times). A three-electrode rechargeable battery using two NPMC metal-free air electrodes to separate ORR and OER also showed good stability (600 cycles for 100 h). First-principles simulations revealed that the N and P co-doping and the highly porous network of the carbon foam may be key features to generate bifunctional activity towards both ORR and OER. The present nanomaterial should also be useful for other electrocatalytic applications as well.

### EXAMPLES

### Sample Preparation

### Preparation of Nitrogen and Phosphorous Co-Doped Carbon (NPC-1000)

For the preparation of NPC-1000, 5 mL aniline monomer was added into 200 mL phytic acid solution (0.1 mM). 0.96 g of ammonium persulfate (APS) was dissolved into the 100 mL deionized (DI) water under stirring. After cooling down to about 4° C., both solutions were mixed together and stirred for overnight. The resultant precipitation was washed with a large amount of DI water and dried at 60° C., followed by annealling at 1000° C. for 2 h under argon. The obtained sample was named NPC-1000.

### Synthesis of RuO₂ Nanoparticles

In order to prepare RuO₂ nanoparticles, RuCl₃.2H₂O was dissolved in a 40 mL solution with equal volumes of water and methanol to give a concentration of 50 mM. The solution was stirred at room temperature for 30 min. 2 M NaOH solution was then dropped into the stirred solution until the pH reached 7.0 and kept stirring for 30 min. The obtained precipitate was separated using a centrifuge, washed with DI water, followed by drying at 60° C. and annealed at 500° C. for 2 h in air.

### Sample Characterization

The morphology and microstructure of the samples were investigated by Field-Emission Scanning Electron Microscopy (FESEM, JSM-6700F, JEOL, Japan). X-ray photoelectron spectroscopy (XPS) measurements were performed on a PHI-5300 ESCA spectrometer (PerkinElmer) with an energy analyzer working in the pass energy mode at 35.75 eV. An Al Kα line was used as the X-ray source. Nitrogen adsorption-desorption isotherms were measured on the AS-6B system (Quantachrome Instruments) at −196° C. The specific surface areas were calculated using adsorption data in a relative pressure ranging from 0.05 to 0.3 by the Brunauerp-Emmett-Teller (BET) method. Pore size distribution curves were computed from the desorption branches of the isotherms using the Barrett, Joyner, and Halenda (BJH) method. Fourier transform infrared spectra (FITR) were recorded on a PerkinElmer spectrum GX FTIR unit. The Raman spectra were collected by the Raman spectroscopy (Renishaw), using 514 nm laser. A CHI 760D electrochemical workstation (CH Instruments) was used to measure the electrocatalytic properties of the samples.

Calculation of Electron Transfer Number (n) and % H₂O⁻ for Oxygen Reduction Reaction

On the basis of RDE data, the electron transfer number per oxygen molecule involved in oxygen reduction can be determined by Koutechy-Levich equation. (Liang, Y. et al. Covalent hybrid of spinel manganese-cobalt oxide and graphene as advanced oxygen reduction electrocatalysts. J. Am. Chem. Soc. 134, 3517-3523 (2012); Zecevic, S. K., Wainright, J. S., Litt, M. H., Gojkovic, S. L. & Savinell, R. F. Kinetics of O₂ reduction on a Pt electrode covered with a thin film of solid polymer electrolyte. J. Electrochem. Soc. 144, 2973-2982 (1997).)

1/j=1/jₖ+1/Bω^{1/2} (1)

where jₖ is the kinetic current and ω is the electrode rotating rate. B is determined from the slope of the Koutechy-Levich (K-L) plots according to the Levich equation as given below:

B=0.2 nF(D_{O}_{₂})^{2/3}υ^{-1/6}C_{O}_{₂} (2)

where n represents the transferred electron number per oxygen molecule. F is Faraday constant (F=96485 C mol⁻¹) is the diffusion coefficient of O₂ in 0.1 M KOH (D₀₂=1.9×10⁻⁵ cm² s⁻¹). v is the kinetic viscosity (υ=0.01 cm² s⁻¹). C_{O2} is the bulk concentration of O₂ (C_{O2}=1.2×10⁻⁶ mol cm⁻³). The constant 0.2 is adopted when the rotation speed is expressed in rpm.

For the RRDE measurements, catalyst inks and electrodes were prepared by the same method as for RDE (see Methods). The disk electrode was scanned at a rate of 5 mV s⁻¹, and the ring potential was constant at 1.3 V vs. RHE. The % HO₂⁻ and transferred electron number per oxygen molecule (n) were determined by the followed equations (Antoine, O. & Durand, R. RRDE study of oxygen reduction on Pt nanoparticles inside Nafion: H₂O₂ production in PEMFC cathode conditions. J. Appl. Electrochem. 30, 839-844 (2000)):

$$\begin{matrix}{HO}_{2}^{-} = 200 \frac{{I}_{r} / N}{{I}_{d} + {I}_{r} / N} & ( 3 ) \\ n = 4 \frac{{I}_{d}}{{I}_{d} + {I}_{r} / N} & ( 4 )\end{matrix}$$

where I_{d} is disk current, Iᵣ is ring current, and N is current collection efficiency of the Pt ring. N was determined to be 0.40.

### Simulation Method and Computational Modeling

### N and P Co-Doped Graphene for ORR/OER Simulations

The computational simulations were carried out by VASP, Vienna ab-initio simulation package, which implemented projector augmented wave pseudo-potentials (PAW) to describe the interaction between nuclei and electrons with density functional theory (DFT). (Kresse, Georg, and Jürgen Furthmüller. Efficient iterative schemes for ab initio total-energy calculations using a plane-wave basis set. Physi. Review B 54, 11169 (1996); Hafner, Jürgen. Ab-initio simulations of materials using VASP: Density-functional theory and beyond. J. Comput. Chem. 29, 2044-2078 (2008).) The computational procedure and models can be seen in details in Li, M., Zhang, L., Xu, Q., Niu, J., Xia, Z. N-doped Graphene as Catalysts for Oxygen Reduction and Oxygen Evolution Reactions: Theoretical Considerations, J. Catal., 314, 66-72(2014). Briefly, the VASP models were built in a shape of graphene supercell with 4×2 hexagon units. The periodic boundary conditions were set up along x-axis to make this model an infinite tape. Hydrogen atoms were added to saturate the carbon atoms locating at both edges of the graphene in y directions. The model is an 8.6 Å×24 Å×18 Å lattice, within which the relaxed graphene piece fits inside. There are more free space in the models along y and z direction for studying the edge effect and ORR/OER reactions on single-layer graphene. The schematics of the models are shown as FIG. 37. For the convenience of identifying the doping and active positions, the positions are named by Arabic number and alphabetical characters. The details of the position site naming are also drawn in FIG. 37.

The K points meshing for Brillioun zone was set up as a 4×1×1 grid making gamma point centered regarding Monkhorst Pack Scheme. The simulation was run with the setup of a 480 eV cutoff energy. The maximum number of ionic steps is 160 and the break condition of the electronic SC-loop is 1.0e-5. The Wigner-Seitz radii of C, N, P, H and O are 0.77 Å, 0.75 Å, 1.06 Å, 0.32 Å and 0.73 Å, respectively. All the simulations were completed in two steps: geometrical optimization and static calculation. For geometrical optimization, the structure was relaxed fully to gain all the atoms sitting at the energy minimum point while for static calculation, the OER/ORR reactions were carried out. Detailed calculations for the adsorption and overpotentials were described elsewhere in Li, M., Zhang, L., Xu, Q., Niu, J., Xia, Z. N-doped Graphene as Catalysts for Oxygen Reduction and Oxygen Evolution Reactions: Theoretical Considerations, J. Catal., 314, 66-72 (2014).

In alkamine environment, OER could occur over N,P co-doped graphene in the following four electron reaction paths,

OH⁻+*→OH* +e⁻ (S1)

OH*+OH⁻→O*+H₂O(l)+e⁻ (S2)

O*+OH⁻→OOH*+e⁻ (S3)

OOH*+OH⁻→*+O₂(g)+H₂O(l)+e⁻ (S4)

where * stands for an active site on the graphene surface, (l) and (g) refer to gas and liquid phases, respectively, and O*, OH* and OOH* are adsorbed intermediates.

The ORR can proceed incompletely through a two-step two-electron pathway that reduces O₂ to hydrogen peroxide, H₂O₂, or completely via a direct four-electron process in which O₂ is reduced directly to water, H₂O, without involvement of hydrogen peroxide. Here the complete reduction cycle is examined because the previous and current results showed that the ORR proceeds on N-doped graphene through the four-electron mechanism. (Hafner, Jurgen. Ab-initio simulations of materials using VASP: Density-functional theory and beyond. J. Comput. Chem. 29, 2044-2078 (2008).) The Eley-Rideal mechanism of ORR in alkaline media is summarized using the following elementary steps (Id.),

O₂+*→O₂ (S5)

O₂*+H₂O(l)+e⁻→OOH*+OH⁻ (S6)

OOH*+e⁻→*+OH⁻ (S7)

O*+H₂O(l)+e⁻→OH*+OH⁻ (S8)

OH*+e⁻→*+OH⁻ (S9)

These reactions (S5) to (S9) for ORR are inversed from the reactions (S1) to (S4) for OER.

In acidic media, the ORR mechanism follows the following elementary steps after the adsorption of O₂ on graphene (Eq. (S5)).

O₂*+H⁺+e⁻→OOH* (S10)

OOH*+H⁺+e⁻→O*+H₂O(l) (S11)

O*+H⁺+e⁻→OH* (S12)

OH*+H⁺+e⁻→*+H₂O(l) (S13)

OER in acidic media is the opposite processes of ORR listed above from Eq. (S13) to (S10).

Since the activation energy of ORR on a catalyst is directly related to its catalytic activity, the activation energy of ORR elemental steps in acidic and alkaline environments was calculated. As depicted in Table 3, among the five barriers in acidic media, H₂O formation in the last step of ORR has the highest value (0.66 eV), and therefore is the rate-limiting step (RLS) for ORR, which is much smaller than that of Pt(111) surface (1.22 eV). (Sha, Y., Yu, T. H., Liu, Y., Merinov, B. V. & Goddard, W. A. Theoretical study of solvent effects on the platinum-catalyzed oxygen reduction reaction. J. Phys. Chem. Lett. 1, 856-861 (2010)) In the alkaline media, the calculated activation energy of the rate-limiting step of Langmuir-Hinshelwood mechanism is ˜0.5 eV for of N, P co-doped graphene, while the activation energies for N-doped graphene and on Pt(111) surface are −0.56-0.62 eV and 0.55 eV, respectively. (Sha, Y., Yu, T. H., Liu, Y., Merinov, B. V. & Goddard, W. A. Theoretical study of solvent effects on the platinum-catalyzed oxygen reduction reaction. J. Phys. Chem. Lett. 1, 856-861 (2010); Yu, L., Pan, X., Cao, X., Hu, P. & Bao, X. Oxygen reduction reaction mechanism on nitrogen-doped graphene: A density functional theory study. J. Catal. 282, 183-190 (2011).) The calculation results in FIG. 6 (vide infra) have also revealed that NPMCs possess ORR activities comparble to, or even better than, that of Pt in alkaline media. Thus, the N, P co-doped nanocarbon could show high catalytic activities in both acidic and alkaline environments.

### Preparation of NPMCs.

PANi aerogel was prepared by an oxidative polymerization in the presence of phytic acid according to the published procedure. (Pan, L. et al. Hierarchical nanostructured conducting polymer hydrogel with high electrochemical activity. Proc. Natl. Acad. Sci. USA 109, 9287-9292 (2012).) Typically, 5 mL of aniline monomer was added into 20 mL phytic acid solution (16%, wt/wt in water). 0.96 g of ammonium persulfate (APS) was dissolved into the 10 mL deionized (DI) water under stirring. After cooling down to 4° C., both solutions were mixed together and kept for overnight without stirring. The resultant hydrogel was washed by immersing in DI water for two days and freeze dried for 24 h to produce polyaniline aerogel for pyrolysis. In order to prepare N, P co-doped mesoporous carbon foams, the PANi aerogel was calcined at desired temperatures (900, 1000, 1100° C.) for 2 h under argon. The obtained samples were designed as NPMC-900, NPMC-1000, and NPMC-1100, respectively. For comparison, phytic acid was removed from the PANi hydrogel by a de-doping process against NH₃.H₂O washing. The pure nitrogen doped mesoporous carbon foam was then prepared by annealing the de-doped PANi aerogel at 1000° C. (designated as NMC-1000). Nitrogen and phosphorous co-doped carbon (NPC-1000) and RuO₂ nanoparticles were also synthesized as references and the preparation processes were shown herein.

### Electrocatalytic Activity Evolution.

All the electrochemical measurements were conducted in a three-electrode configuration at room temperature (˜25° C.). The potential, measured against an Ag/AgCl electrode, was converted to the potential versus the reversible hydrogen electrode (RHE) according to E_{vs RHE}=E_{vs Ag/AgCl}+E_{ø Ag/AgCl}+0.059 pH. To prepare the working electrode, 5 mg of NPMC samples were dispersed in an aqueous solution containing 0.95 mL DI water and 0.05 mL of 5 wt % Nafion under sonication. 6 μL of the obtained homogeneous catalyst ink was dropped onto a mirror polished glassy carbon electrode. The mass loading is 0.15 mg cm⁻² unless otherwise noted. Pt/C (20 wt %, ETEK) electrode was prepared by using the same procedure. 0.1 M KOH aqueous solution saturated with oxygen was employed as the electrolyte unless otherwise stated.

For the Zn-air battery test, the air electrode was prepared by uniformly coating the as-prepared catalyst ink onto a carbon paper (SPECTRACARB 2040-A, Fuel Cell store) and dried at 80° C. for 2 h. The mass loading is 0.5 mg cm⁻² unless otherwise noted. A Zn plate was used as an anode. Both electrodes were assembled in a home-made Zn-air battery and 6 M KOH aqueous solution was used as an electrolyte unless otherwise stated. The same procedure was used to prepare air electrodes with catalyst mass ratio of 1:3 as the ORR and OER electrodes respectively in three-electrode rechargeable Zn-air battery.

Embodiments of the technology have been described above and modifications and alterations may occur to others upon the reading and understanding of this specification. The claims as follows are intended to include all modifications and alterations insofar as they come within the scope of the claims or the equivalent thereof.

1. A co-doped carbon material comprising a mesoporous nanocarbon foam co-doped with nitrogen and phosphorous.

2. The co-doped carbon material of claim 1, wherein the mesoporous nanocarbon foam co-doped with nitrogen and phosphorous is substantially free of metal.

3. The co-doped carbon material of claim 2, wherein the mesoporous nanocarbon foam co-doped with nitrogen and phosphorous comprises from about 1 wt. % to about 10 wt. % nitrogen and about 0.1 wt. % to about 5 wt. % phosphorous.

4. The co-doped carbon material of claim 3, wherein the total pore volume of the mesoporous nanocarbon foam co-doped with nitrogen and phosphorous is about 0.3 to about 2.0 cm³g⁻¹.

5. A bifunctional catalyst comprising the co-doped carbon material of claim 1, wherein the catalyst is an oxygen reduction reaction (ORR) and oxygen evolution reaction (OER) catalyst.

6. An electrochemcial cell comprising at least one electrode, wherein the at least one electrode comprises a co-doped nanocarbon material comprising a mesoporous carbon foam co-doped with nitrogen and phosporous.

7. The electrochemical cell of claim 6, wherein the mesoporous nanocarbon foam co-doped with nitrogen and phosphorous is substantially free of metal.

8. The electochemical cell of claim 7, wherein the mesoporous nanocarbon foam co-doped with nitrogen and phosphorous comprises from about 1 wt. % to about 10 wt. % nitrogen and about 0.1 wt. % to about 5 wt. % phosphorous.

9. The electrochemical cell of claim 6 comprising at least two electrodes, at least one of which comprises the mesoporous nanocarbon foam co-doped with nitrogen and phosphorous.

10. The electrochemical cell of claim 6, comprising three electrodes, wherein two of the electrodes comprise the mesoporous nanocarbon foam co-doped with nitrogen and phosphorous.

11. The electrochemical cell of claim 9, wherein each electrode comprises the mesoporous carbon foam co-doped with nitrogen and phosphorous.

12. The electrochemical cell of claim 6, wherein the electrochemical cell is a battery.

13. The electrochemical cell of claim 12 wherein the battery is a zinc-air battery.

14. The electrochemical cell of claim 13, wherein the zinc-air battery is a rechargeable battery.

15. A process for making mesoporous carbon foams comprising (i) forming a polyanline aerogel, and (ii) pyrolyzing the polyaniline aerogel in the presence of phytic acid.

16. The process of claim 15, wherein forming the polyanline aerogel comprises a template-free polymerization of aniline.

17. The process of claim 15, wherein the polyaniline aerogels are formed by (i) polymerizing aniline monomers in the presence of phytic acid to produce a polyaniline hydrogel and (ii) freeze drying the polyaniline hydrogel to form an aerogel.

18. The process of claim 15, wherein the polyaniline aerogels are pyrolyzed in argon.

19. The process of claim 15, wherein the pyrolysis is conducted at a temperature in the range of about 800° C. to about 1200° C.

20. The process of claim 16, wherein the pyrolysis is conducted at a temperature in the range of about 900° C. to about 1100° C.

21. The process of claim 17, wherein the pyrolysis is conducted at a temperature in the range of about 900° C. to about 1000° C.

22. The process of claim 15, wherein the ratio of aniline to phytic acid is about 3:1 or greater.
